(19) United States
(12) Patent Application Publication
(10) Pub. No.: US 2026/0185369 A1
(43) Pub. Date: Jul. 2, 2026

(54) SMART SAFE BOOTH FOR CRIME PREVENTION

(71) Applicant: GuardianTech Inc., Seoul (KR)

(72) Inventor: DANIEL KIM, Seoul (KR)

(21) Appl. No.: 19/436,136

(22) Filed: Dec. 30, 2025

(30) Foreign Application Priority Data
Dec. 31, 2024 (KR) 10-2024-0202622

(51) Int. Cl. E04H 1/12; A62C 2/06; B64U 70/92

(52) U.S. Cl. CPC E04H 1/1205; A62C 3/14; B64U 70/92

(57) ABSTRACT

Disclosed is a smart safe booth for crime prevention. The smart safe booth includes a booth body disposed at a predefined location on the ground, having an internal space defined therein. An opening/closing unit is provided at a predefined position of the booth body to open and close the internal space. The booth further includes a ventilation unit disposed to ventilate the internal space, and a fire extinguishing unit configured to suppress a fire when a fire occurs within the booth body. A communication unit is provided to perform communication with an external device in a wired or wireless manner. Additionally, a drone station is arranged on a top of the booth body, where a drone is seated in a standby state. A controller controls the operations of the aforementioned units and transmits flight control signals to the drone to manage its flight.

### CROSS-REFERENCE TO RELATED APPLICATION

This application claims priority from Korean Patent Application No. 10-2024-0202622 filed on Dec. 31, 2024 in the Korean Intellectual Property Office, and all the benefits accruing there from under 35 U.S.C. 119, the contents of which in its entirety are herein incorporated by reference.

### BACKGROUND

### Field

The present disclosure relates to a smart safe booth for crime prevention. More specifically, the present disclosure relates to a smart safe booth for crime prevention that allows a victim in an emergency situation due to the occurrence of a crime in an external space to immediately and safely evacuate therein, promotes the safety of the victim from threatening situations from the outside, and, in response to that a dangerous situation is recognized, uses a drone to notify a control center and a police center of the situation outside the safe booth in real time.

### Description of Related Art

Various crimes such as kidnapping, violence, robbery, and murder are occurring regardless of whether it is a public place or not. To prevent such crimes, conventionally, security personnel are increased in the jurisdiction, Crime Prevention Through Environmental Design (CPTED) plans are implemented, or connected security cameras are installed in various places to prevent and monitor crimes.

Among these solutions, the conventional crime prevention and surveillance system using security cameras based on CPTED monitors images captured by security cameras and stores the captured images by time. Accordingly, this solution searches for the stored images captured when the crime occurs, and monitors the crime occurrence situation, such that there is an effect of lowering the crime rate. Furthermore, various technologies (mobile phones, emergency bells, etc.) for notifying emergency situations exist.

However, the above-mentioned solutions have limitations in the role of active crime blocking. Moreover, in the case of the C3 system, there is a limitation in the reporting means because upon the occurrence of a crime, the victim or a crime witness contacts the police agency and reports the crime to the police agency. In addition, the reporting is possible only after a predefined time duration has elapsed since the crime occurred, thereby making it difficult to arrest the criminal due to the delayed reporting and thus reducing the effect of preventing crime.

In addition, the biggest problem with these conventional technologies lies in that urgent crime occurrence situations happen in real time. This means that there is a high probability that a crime will be committed. The above solutions are merely means for arrest after the crime has occurred. However, it is a reality that it is difficult to implement fundamental blocking of the crime such as safely protecting the crime victims and preventing crimes

Generally, when an emergency situation occurs in which a victim may be harmed by an attacker in an external space such as a road, the victim runs away to another place to avoid the attack and asks for help from the surrounding people, or hides inside a surrounding building or a structure around the roadside. Then, the victim reports the crime situation to the police agency. However, this has a problem that it is highly likely that the crime cannot be prevented in advance and damage to the victim due to the occurrence of a crime cannot be substantially prevented.

### PRIOR ART DOCUMENT

### Patent Document

Patent Document 1: Korean Patent No. 10-1399185 (Registration Date: May 19, 2014)

### SUMMARY

The present disclosure has been devised to solve the above-mentioned problems, and the purposes of the present disclosure are as follows.

A purpose of the present disclosure is to provide a smart safe booth for crime prevention that allows a victim in an emergency situation due to the occurrence of a crime in an external space to immediately and safely evacuate into the safe booth, thereby safely protecting the victim from threatening situations from the outside out of the booth.

In addition, another purpose of the present disclosure is to provide a smart safe booth for crime prevention that, when a dangerous situation is recognized, operates a drone to capture an image of the external situation to the safe booth in real time and transmit the captured image to the control center and the police center.

In addition, still another purpose of the present disclosure is to provide a smart safe booth for crime prevention in which the safe booth is installed at a predefined location on the ground and damage to the booth by physical impact from the outside is prevented, or the installation position is prevented from being changed.

In addition, still yet another purpose of the present disclosure is to provide a smart safe booth for crime prevention in which the safe booth body descends into the underground when the victim completes evacuation to the safe booth, thereby making the victim free from additional crimes on the ground.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims or combinations thereof.

To achieve the above purposes, the present disclosure provides a smart safe booth for crime prevention as follows.

The smart safe booth for crime prevention includes: a booth body disposed at a predefined location on the ground and having an internal space defined therein; an opening/closing unit provided at a predefined position of the booth body to open and close the internal space of the booth body; a ventilation unit disposed in the internal space of the booth body to ventilate the internal space of the booth body; a fire extinguishing unit for suppressing a fire when a fire occurs in the internal space of the booth body; a communication unit disposed in the internal space of the booth body to perform communication with an external communication device in a wired or wireless communication manner; a drone station disposed on a top of the booth body, where a drone flying based on a flight control signal is seated on the drone station in a standby state; and a controller configured to control an operation of each of the opening/closing unit, the ventilation unit, the fire extinguishing unit, and the communication unit, and to transmit the flight control signal to the drones to control the flight of the drones.

In accordance with some embodiments of the smart safe booth for crime prevention, the controller is configured to: receive victim occurrence information including a victim's personal information and location information of a victim's wireless communication device from a main server in a wireless communication manner; in response to that the location information of the victim's wireless communication device approaches location information of the booth body, drive the opening/closing unit to open the internal space of the booth body; and in response to that the victim is located in the internal space of the booth body, drive the opening/closing unit to close the internal space of the booth body.

In accordance with some embodiments of the smart safe booth for crime prevention, the booth body is made of bulletproof metal, wherein the booth body is provided with a water discharge unit.

In accordance with some embodiments of the smart safe booth for crime prevention, the water discharge unit includes: a water level sensor for measuring a water level value from a bottom of the internal space of the booth body and transmitting the measured water level to the controller; a water discharge line; and a water discharge pump installed at the water discharge line.

In accordance with some embodiments of the smart safe booth for crime prevention, in response to that the water level value measured by the water level sensor reaches a preset reference water level value, the controller is configured to drive the water discharge pump to forcibly discharge water present on the bottom of the internal space of the booth body to an outside out of the booth body through the water discharge line.

In accordance with some embodiments of the smart safe booth for crime prevention, a flame-retardant layer having a predefined thickness is formed on each of an outer surface and an inner surface of the booth body.

In accordance with some embodiments of the smart safe booth for crime prevention, the ventilation unit includes a fan module rotated under control of the controller, wherein a ventilation hole is formed at a predefined position of the booth body, wherein the fan module is installed in the ventilation hole, wherein a grill member covering the ventilation hole and having a predefined strength or greater is installed in the booth body.

In accordance with some embodiments of the smart safe booth for crime prevention, anti-intrusion pins protruding sharply outwardly are formed at multiple positions of the grill member, wherein each of the anti-intrusion pins extends to be inclined downwards.

In accordance with some embodiments of the smart safe booth for crime prevention, the fire extinguishing unit further includes an auxiliary sprayer for spraying a fire extinguishing agent into the ventilation hole, wherein a temperature sensor for measuring a temperature value and transmitting the measured temperature value to the controller is provided in the ventilation hole, wherein in response to that the temperature value measured by the temperature sensor in the ventilation hole reaches a preset abnormal temperature value, the controller is configured to operate the auxiliary sprayer.

In accordance with some embodiments of the smart safe booth for crime prevention, a water tank is further installed under a lower end of the ventilation hole, wherein the water tank is connected to an auxiliary water discharge line, wherein an auxiliary water discharge pump is installed at the auxiliary water discharge line, wherein a moisture sensor is disposed in the water tank, wherein in response to that the moisture sensor moisture detects moisture in the water tank, the controller is configured to operate the auxiliary water discharge pump to forcibly discharge the moisture formed in the water tank to the outside out of the booth body through the auxiliary water discharge line.

In accordance with some embodiments of the smart safe booth for crime prevention, a mesh is further installed at the end of the water discharge line and the end of the auxiliary water discharge line.

In accordance with some embodiments of the smart safe booth for crime prevention, a backflow prevention valve driven under the control of the controller is further installed at each of the water discharge line and the auxiliary water discharge line.

In accordance with some embodiments of the smart safe booth for crime prevention, the controller is configured to drive each of the backflow prevention valves upon receiving the victim occurrence information.

In accordance with some embodiments of the smart safe booth for crime prevention, a drone station receiving groove is formed in the upper end of the booth body, wherein a lift is installed under the drone receiving groove and is connected to the drone station, wherein the controller is configured to drive the lift to move downwardly such that the drone station descends and is received into the drone station receiving groove such that the drone is in the standby state while being seated on the drone station.

In accordance with some embodiments of the smart safe booth for crime prevention, the controller is configured to: upon receiving the victim occurrence information, transmit the flight control signal to the drone; control the drone to fly repeatedly within a set radius around the booth body; and control a camera provided in the drone to capture an image of a scene within the set radius in real time and to transmit the captured image to the main server.

In accordance with some embodiments of the smart safe booth for crime prevention, in response to that the controller receives the victim occurrence information, the controller is configured to receive movement path information of the victim's wireless communication device from the main server, and control the drones to fly along the movement path information, determine whether a preset criminal image is contained in the image captured from the cameras of the drones, and in response to that the preset criminal image is contained in the image captured from the cameras of the drones, transmit the image containing the preset criminal image to a police agency server.

In accordance with some embodiments of the smart safe booth for crime prevention, the police agency server is configured to select location information of the image containing the preset criminal image, and transmit a dispatch signal to a wireless module of a security management vehicle included within a set radius based on the selected location information.

In accordance with some embodiments of the smart safe booth for crime prevention, a base plate made of metal and having a predefined thickness is installed under the lower end of the booth body, rotators are installed at multiple positions on the lower end of the base plate, fastening members are respectively installed on the rotation shafts of the rotators, an installation plate having a predefined depth is installed on the ground, and fastening blocks having fastening holes fastened to the fastening members are installed on the installation plate.

In accordance with some embodiments of the smart safe booth for crime prevention, the controller is configured to rotate the rotation shafts of the rotators to fasten the fastening members to the fastening holes of the fastening blocks.

In accordance with some embodiments of the smart safe booth for crime prevention, an impact sensor for measuring an impact force from the outside and transmitting the measurement to the controller is installed on the booth body.

In accordance with some embodiments of the smart safe booth for crime prevention, first concave-convex protrusions are formed on the lower end of the base plate, and second concave-convex protrusions concave-convexly coupled to or engaged with the first concave-convex protrusions are formed on the upper end of the installation plate.

In accordance with some embodiments of the smart safe booth for crime prevention, electromagnets magnetized to have a first polarity according to the application of current thereto are installed on the first concave-convex protrusions, and polar members having a second polarity to generate an attractive force with respect to the magnetized electromagnets are installed on the second concave-convex protrusions.

In accordance with some embodiments of the smart safe booth for crime prevention, when the measured impact force is equal to or greater than a preset reference impact force, the controller is configured to drive a current provider to provide the current to the electromagnet, thereby forcibly attaching the electromagnet and the polar member to each other through a magnetic force.

In accordance with some embodiments of the smart safe booth for crime prevention, a lifting device is installed under the lower end of the booth body, the lifting device lifts and lowers the booth body under the control of the controller, cover members connected to the shafts of respective cylinders and protruding outwardly and horizontally in all directions according to the extension operation of the shafts are provided on and arranged around the periphery of the upper end of the booth body, and the cylinder is configured to horizontally and outwardly extend the shaft thereof under the control of the controller.

In accordance with some embodiments of the smart safe booth for crime prevention, an evacuation groove having a predefined depth is formed in the ground, the lifting device lowers the booth body so as to be positioned in the evacuation groove.

In accordance with some embodiments of the smart safe booth for crime prevention, when the booth body is lowered into the evacuation groove through the lifting device, the controller is configured to operate the cylinders to extend the shafts of the cylinders such that the cover members connected thereto horizontally and outwardly extend to cover the upper portion of the evacuation groove such that the evacuation groove is sealed from the space on top of the ground.

In accordance with some embodiments of the smart safe booth for crime prevention, the booth body further includes an auxiliary ventilation unit.

In accordance with some embodiments of the smart safe booth for crime prevention, the auxiliary ventilation unit includes an outside air inflow pipe connecting the internal space of the booth body to the space on the ground to introduce outside air into the inner space of the booth body therethrough, an outside air inflow fan installed at the outside air inflow pipe to introduce the outside air into the inner space of the booth body through the outside air inflow pipe under the control of the controller, and an outside air outflow pipe connecting the internal space of the booth body to the space on the ground to discharge the introduced outside air into the inner space of the booth body to the outside therethrough.

In accordance with some embodiments of the smart safe booth for crime prevention, each of the outside air inflow pipe and the outside air outflow pipe passes through the underground and is connected to the space on the ground and is formed as a non-combustible and flexible pipe.

In accordance with some embodiments of the smart safe booth for crime prevention, each of an outside end of the outside air inflow pipe on the ground and an outside end of the outside air outflow pipe on the ground is formed to be inclined downwards.

The smart safe booth for crime prevention according to the present disclosure allows a victim in an emergency situation due to the occurrence of a crime in an external space to immediately and safely evacuate into the safe booth, thereby safely protecting the victim from threatening situations from the outside out of the booth.

In addition, in the smart safe booth for crime prevention according to the present disclosure, when a dangerous situation is recognized, the controller operates a drone to capture an image of the external situation to the safe booth in real time and transmit the captured image to the control center and the police center.

In addition, in the smart safe booth for crime prevention according to the present disclosure, the safe booth is installed at a predefined location on the ground and damage to the booth by physical impact from the outside is prevented, or the installation position is prevented from being changed.

In addition, in the smart safe booth for crime prevention according to the present disclosure, the safe booth body descends into the underground when the victim completes evacuation to the safe booth, thereby making the victim free from additional crimes on the ground.

In addition to the above-mentioned effects, specific effects of the present disclosure will be described together while explaining specific details for carrying out the disclosure below.

### BRIEF DESCRIPTION OF DRAWINGS

FIG. 1 is a perspective view showing a smart safe booth for crime prevention according to the present disclosure.

FIG. 2 is a configuration diagram of the smart safe booth for crime prevention according to the present disclosure in a front view.

FIG. 3 is a configuration diagram of the smart safe booth for crime prevention according to the present disclosure in a top view.

FIG. 4 is a block diagram showing a communication of an opening/closing unit, a ventilation unit and a fire extinguishing unit with a communication unit of the safe booth according to the present disclosure.

FIG. 5 is a diagram showing an example of the configuration of a safe booth including a fireproof cloth according to the present disclosure.

FIG. 6 and FIG. 7 are diagrams showing a working state of the fireproof cloth of FIG. 5.

FIG. 8 is a diagram showing an example in which a grill member is installed around the ventilation hole of the booth body according to the present disclosure.

FIG. 9 is a diagram showing an example in which an auxiliary sprayer is provided around the ventilation hole according to the present disclosure.

FIG. 10 is a diagram showing an example in which a configuration for discharging water is applied to the booth body according to the present disclosure.

FIG. 11 is a diagram showing an example in which a water tank is provided under the ventilation hole according to the present disclosure.

FIG. 12 is a diagram showing a water discharge line and an auxiliary water discharge line according to the present disclosure.

FIG. 13 is a diagram showing a drone station receiving structure according to the present disclosure.

FIG. 14 is a block diagram showing a function of capturing images through drones and selecting a criminal based on the images.

FIG. 15 is a diagram showing an example of the installation of the booth body according to the present disclosure.

FIG. 16 is a diagram showing an example in which the booth body can be accommodated underground according to the present disclosure.

FIG. 17 is a diagram showing a state in which the booth body is accommodated underground.

FIG. 18 is a block diagram showing a crisis response system included in the safe booth according to the present disclosure.

FIG. 19 is a block diagram showing an example in which the crime emergency management system according to the present disclosure further includes a movement monitoring unit.

FIG. 20 is a block diagram showing an example in which the crisis response system according to the present disclosure includes a variable movement information receiving unit and an additional emergency situation occurrence determination unit.

FIG. 21 is a block diagram showing the operation of the additional emergency situation occurrence determination unit according to the present disclosure.

FIG. 22 is a block diagram showing an example in which the crime emergency management system according to the present disclosure includes a victim abnormal state checking unit.

FIG. 23 is a block diagram showing a configuration including an example in which an emergency notification module operates in a remote control manner.

FIG. 24 is a diagram showing an example of the configuration of a safe booth according to the present disclosure.

FIG. 25 is a block diagram showing a crime emergency management system including a monitoring server.

FIG. 26 is a diagram showing an example of suppressing the occurrence of additional crimes.

FIG. 27 is a block diagram showing the operation of a crime emergency management system including a drone flight controller.

### DETAILED DESCRIPTIONS

Advantages and features of the present disclosure, and a method of achieving the advantages and features will become apparent with reference to embodiments described later in detail together with the accompanying drawings. However, the present disclosure is not limited to the embodiments as disclosed below, but may be implemented in various different forms. Thus, these embodiments are set forth only to make the present disclosure complete, and to completely inform the scope of the present disclosure to those of ordinary skill in the technical field to which the present disclosure belongs, and the present disclosure is only defined by the scope of the claims.

A shape, a size, a ratio, an angle, a number, etc. disclosed in the drawings for describing the embodiments of the present disclosure are exemplary, and the present disclosure is not limited thereto. The same reference numerals refer to the same elements herein. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that the terms “comprise”, “including”, “include”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list. In interpretation of numerical values, an error or tolerance therein may occur even when there is no explicit description thereof.

In addition, it will also be understood that when a first element or layer is referred to as being present “on” a second element or layer, the first element may be disposed directly on the second element or may be disposed indirectly on the second element with a third element or layer being disposed between the first and second elements or layers. It will be understood that when an element or layer is referred to as being “connected to”, or “coupled to” another element or layer, it may be directly on, connected to, or coupled to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

Further, as used herein, when a layer, film, region, plate, or the like may be disposed “on” or “on a top” of another layer, film, region, plate, or the like, the former may directly contact the latter or still another layer, film, region, plate, or the like may be disposed between the former and the latter. As used herein, when a layer, film, region, plate, or the like is directly disposed “on” or “on a top” of another layer, film, region, plate, or the like, the former directly contacts the latter and still another layer, film, region, plate, or the like is not disposed between the former and the latter. Further, as used herein, when a layer, film, region, plate, or the like may be disposed “below” or “under” another layer, film, region, plate, or the like, the former may directly contact the latter or still another layer, film, region, plate, or the like may be disposed between the former and the latter. As used herein, when a layer, film, region, plate, or the like is directly disposed “below” or “under” another layer, film, region, plate, or the like, the former directly contacts the latter and still another layer, film, region, plate, or the like is not disposed between the former and the latter.

In descriptions of temporal relationships, for example, temporal precedent relationships between two events such as “after”, “subsequent to”, “before”, etc., another event may occur therebetween unless “directly after”, “directly subsequent” or “directly before” is not indicated.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

The features of the various embodiments of the present disclosure may be partially or entirely combined with each other, and may be technically associated with each other or operate with each other. The embodiments may be implemented independently of each other and may be implemented together in an association relationship.

It will be understood that when an element or layer is referred to as being “connected to”, or “coupled to” another element or layer, it may be directly on, connected to, or coupled to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

The features of the various embodiments of the present disclosure may be partially or entirely combined with each other, and may be technically associated with each other or operate with each other. The embodiments may be implemented independently of each other and may be implemented together in an association relationship.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Next, a smart safe booth for crime prevention of the present disclosure will be described with reference to the accompanying drawings.

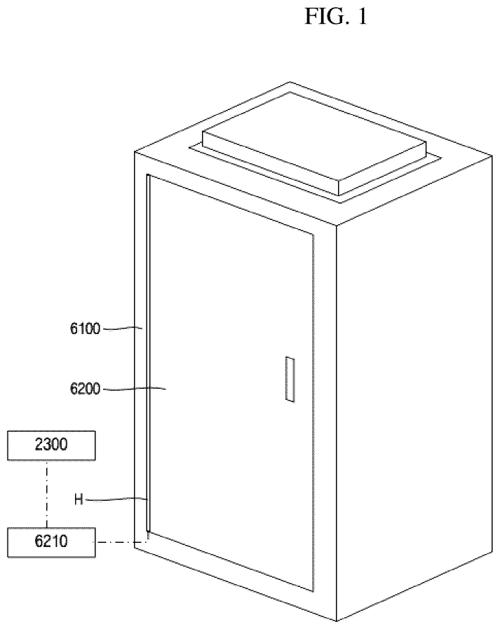

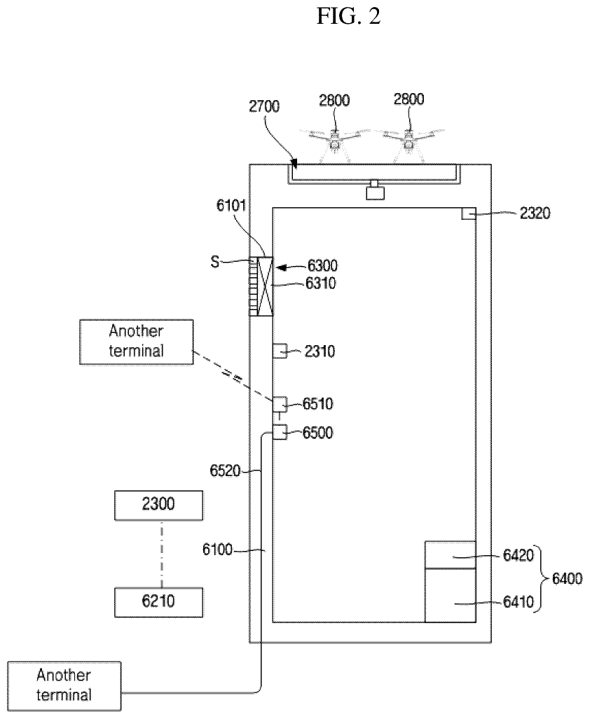

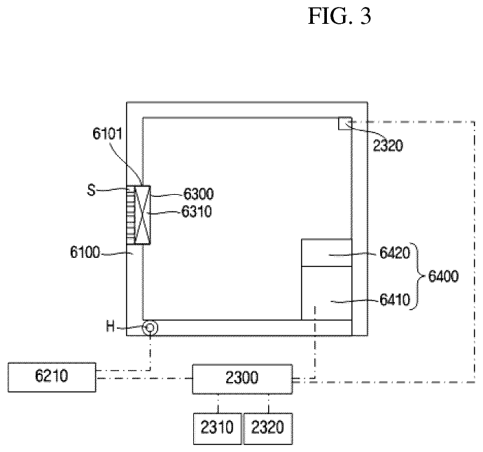

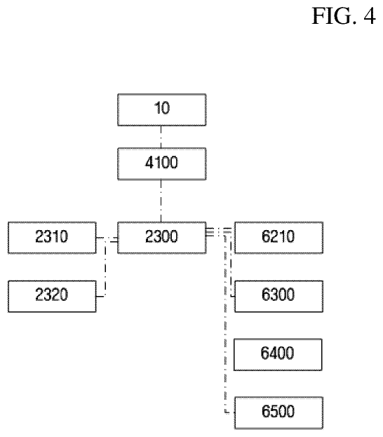

FIG. 1 is a perspective view showing a smart safe booth for crime prevention according to the present disclosure. FIG. 2 is a configuration diagram of the smart safe booth for crime prevention according to the present disclosure in a front view. FIG. 3 is a configuration diagram of the smart safe booth for crime prevention according to the present disclosure in a top view. FIG. 4 is a block diagram showing a communication of an opening/closing unit, a ventilation unit and a fire extinguishing unit with a communication unit of the safe booth according to the present disclosure.

The smart safe booth for crime prevention of the present disclosure may be installed on the ground. In one example, the smart saft booth may be installed movably.

### Booth Body 6100

Referring to FIGS. 1 to 4, a smart safe booth 6000 of the present disclosure has the booth body 6100 in which an internal space is formed.

The booth body 6100 has an opening/closing unit 6200. The opening/closing unit 6200 is installed at a predefined position of the booth body 6100.For example, an opening is formed in the booth body 6100, and the opening/closing unit 6200 may be pivotally installed on one side of the opening via a hinge H. The hinge H is axially connected to a rotating shaft (not shown) of a rotary motor 6210.

Under the driving of the rotary motor 6210, the opening/closing unit 6200 pivots around the hinge H, and accordingly, the internal space of the booth body 6100 may be opened and closed. The opening/closing unit 6200 may be embodied as a pivotable door. The booth body 6100 is installed at a set position on the ground.

The rotary motor 6210 is rotated under the control of the controller 2300. As the opening/closing unit 6200 pivots, the internal space of the booth body 6100 is opened and closed.

When the controller 2300 receives victim occurrence information including the victim's personal information and the location information of a victim's wireless communication device 10 from a main server 4100 through wireless communication, and when the location of the victim's wireless communication device 10 approaches the location of the booth body 6100, the controller 2300 is configured to drive the opening/closing unit 6200 to open the internal space of the booth body 6100. When the victim is located in the internal space of the booth body 6100, the controller 2300 is configured to drive the opening/closing unit 6200 to close the internal space of the booth body 6100 and to operate a ventilation unit 6300, a fire extinguishing unit 6400, and a communication unit 6500.

That is, the controller 2300 receives the victim occurrence information. In response to that the location information of the victim's wireless communication device 10 approaches the location information of the booth body 6100 based on the received information, the controller 2300 is configured to drive the rotary motor 6210 to pivot the opening/closing unit 6200 around the hinge such that the internal space of the booth body 6100 is opened. Thus, the victim may evacuate to the internal space of the booth body 6100.

A sensor 2310 for recognizing a person as the victim is installed in the internal space of the booth body 6100. The sensor 2310 may include a proximity sensor, an ultrasonic sensor, an infrared sensor, etc. When the sensor 2310 detects the victim, the sensor transmits a detection signal to the controller 2300. Upon reception of the detection signal, the controller 2300 is configured to drive the opening/closing unit 6200 to close the internal space of the booth body 6100. Thus, the victim may safely wait in the internal space of the booth body 6100.

The booth body 6100 may be made of bulletproof metal. Thus, the booth body 6100 may be safely protected from physical impact using firearms, etc.

A flame-retardant layer 6110 may be formed on an inner surface and an outer surface of the booth body 6100. Thus, the booth body 6100 may be safely protected from the fire even when being exposed to arson from the outside.

### Ventilation Unit 6300

The ventilation unit 6300 is installed at the booth body 6100. The ventilation unit 6300 has a fan module 6310 equipped with a fan.

The fan module 6310 is driven under the control of the controller 2300. A ventilation hole 6101 is formed in the booth body 6100. The fan module is installed in the ventilation hole.

In this regard, slit holes S are formed in front of the ventilation hole 6101. Thus, it may be difficult for an outside criminal to enter the inside of the booth body 6100 through the ventilation hole 6101.

### Fire extinguishing Unit 6400

When a fire occurs in the internal space of the booth body 6100 according to the present disclosure, the fire extinguishing unit 6400 installed on the inner surface of the booth body 6100 may suppress the fire.

The fire extinguishing unit 6400 includes a fire extinguishing agent supplier 6410 for supplying a fire extinguishing agent, and a fire extinguishing agent sprayer 6420 that receives the fire extinguishing agent from the fire extinguishing agent supplier 6410 and sprays the same into the internal space of the booth body 6100.

The fire extinguishing agent supplier 6410 is driven under the control of the controller 2300.

Further, the booth body 6100 is equipped with a fire detector 2320 that detects the occurrence of a fire in the internal space of the booth body 6100 and transmits a fire detection signal to the controller 2300.

When the fire occurrence is detected, the controller 2300 is configured to drive the fire extinguishing agent supplier 6410 to spray the fire extinguishing agent into the internal space of the booth body 6100 to extinguish the fire.

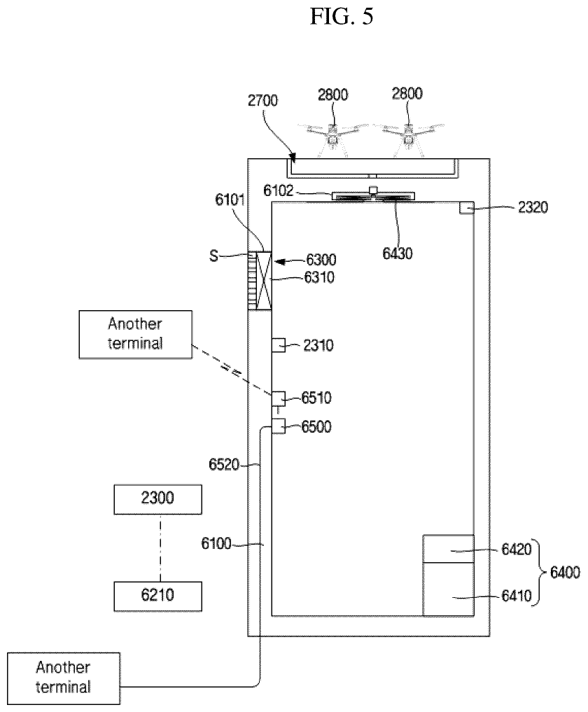

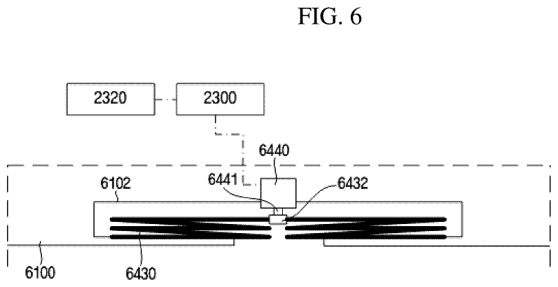

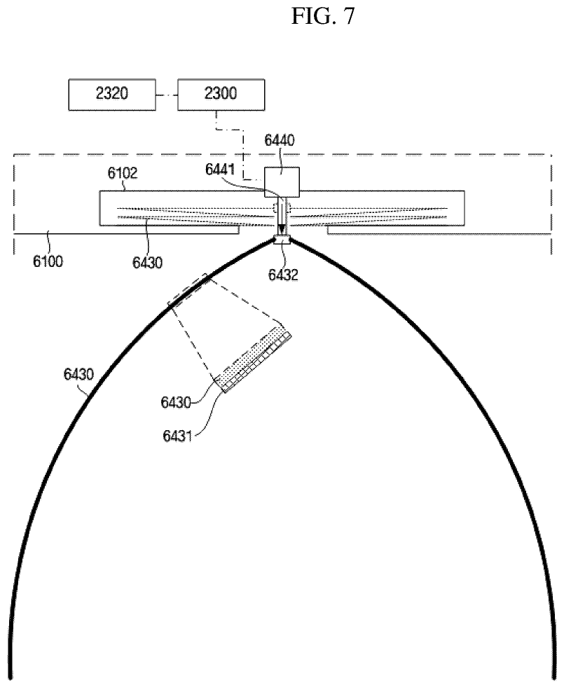

FIG. 5 is a diagram showing an example of the configuration of a safe booth including a fireproof cloth according to the present disclosure. FIG. 6 and FIG. 7 are diagrams showing a working state of the fireproof cloth of FIG. 5.

Referring to FIGS. 5 to 7, the flexible fireproof cloth 6430 made of a fireproof material may be installed in the ceiling defining the internal space of the booth body 6100.

The fireproof cloth 6430 may be supported on elastic wires 6431 having heat resistance.

The fireproof cloth 6430 may be accommodated in a receiving groove 6102 formed in the ceiling defining the internal space of the booth body 6100 in a folded state and thus in a standby state.

A cylinder 6440 having a shaft 6441 protruding downwards may be installed inside the receiving groove 6102. A fireproof connecting member 6432 to which a center of the fireproof cloth 6430 is connected is installed at a lower end of the shaft 6441.

When the fire is detected, the controller 2300 is configured to drive the cylinder 6440 to extend the shaft 6441 downwards such that the fireproof connecting member 6432 is lowered so as to be positioned under the ceiling. Thus, the fireproof cloth 6430 connected to the fireproof connecting member connected to the end of the protruding shaft 6441 is withdrawn out of the receiving groove 6102 and thus is unfolded and spread into the inner space of the booth body.

That is, the fireproof cloth 6430 may be unfolded under the elasticity of the elastic wires 6431. At this time, the shape in which the fireproof cloth 6430 is unfolded into the inner space of the booth body may be a dome shape.

Thus, when the fire occurs, the victim may be positioned inside the fireproof cloth 6430 unfolded in the dome shape and covered therewith. The victim may be safely protected from the fire.

### Communication Unit 6500

Referring to FIGS. 1 to 4, the communication unit 6500 according to the present disclosure may be a device for performing wireless communication and wired communication. In the case of wireless communication, communication of the communication unit 6500 with a first external terminal may be established via a separate wireless module 6510. In the case of wired communication, the communication unit 6500 is connected to a second external terminal to the booth body via a separate wired communication line 6520. In this regard, the wired communication line 6520 passes through the bottom of the booth body 6100 and is buried underground. Therefore, after the victim evacuates into the inner space of the booth body 6100 in an emergency situation, communication between the communication unit 6500 and the second external terminal may be established to notify the emergency situation through wired communication even though the criminal interferes with the wireless communication.

### Drone station 2700

Referring to FIGS. 1 to 4, the drone station 2700 according to the present disclosure may be disposed on an upper end of the booth body 6100.

Drones 2800 may standby on the drone station 2700. The controller 2300 according to the present disclosure may transmit a flight control signal to control the flight of the drones 2800. The controller 2300 may control the flight of the drones 2800 through a drone flight controller 5000.

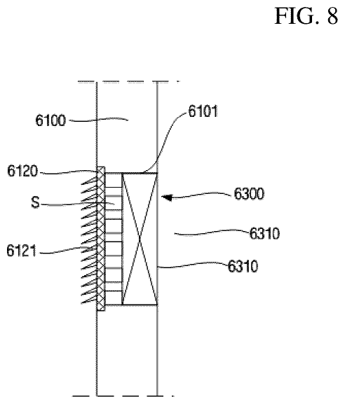

FIG. 8 is a diagram showing an example in which a grill member is installed around the ventilation hole of the booth body according to the present disclosure.

Referring to FIG. 8, a grill member 6120 covering the ventilation hole 6101 and having a predefined strength or greater is installed in the booth body 6100.

Anti-intrusion pins 6121 protruding sharply outwardly are formed at multiple positions of the grill member 6120.

Each of the anti-intrusion pins 6121 extends to be inclined downwards.

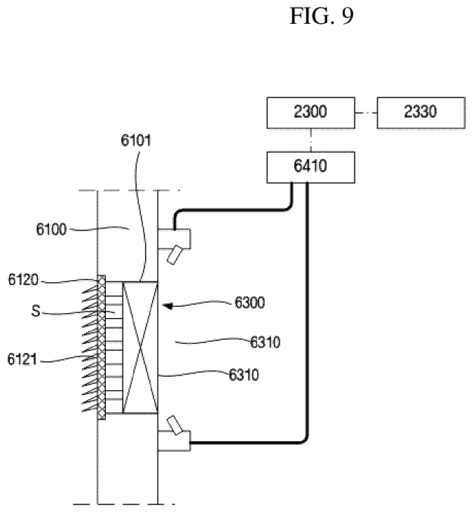

FIG. 9 is a diagram showing an example in which an auxiliary sprayer is provided around the ventilation hole according to the present disclosure.

Referring to FIG. 9, the fire extinguishing unit 6400 further includes an auxiliary sprayer 6450 for spraying the fire extinguishing agent into the ventilation hole 6101.

A temperature sensor 2330 that measures a temperature value and transmits the temperature sensor to the controller 2300 is provided in the ventilation hole 6101.

The controller 2300 may drive the auxiliary sprayer 6450 in response to that the temperature value measured in the temperature sensor installed in the ventilation hole 6101 reaches a preset abnormal temperature value.

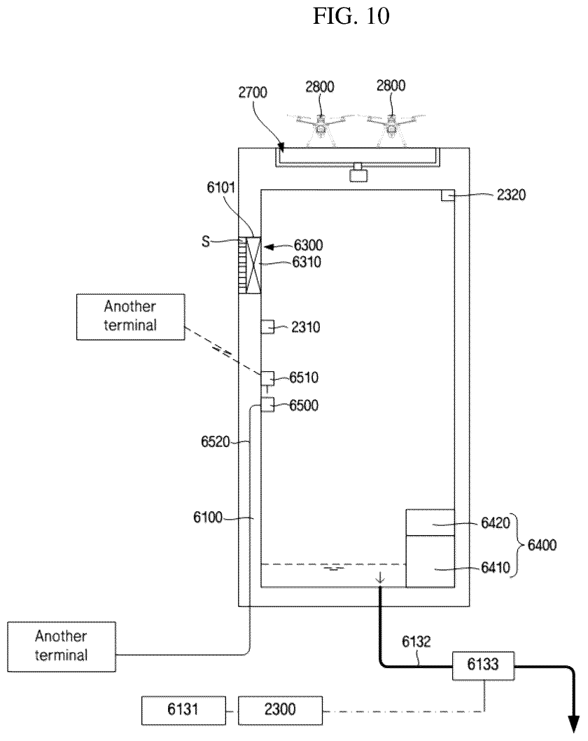

FIG. 10 is a diagram showing an example in which a structure for discharging water is applied to the booth body according to the present disclosure.

Referring to FIG. 10, a water discharge unit 6130 is installed at the booth body 6100 according to the present disclosure.

The water discharge unit 6130 includes a water level sensor 6131 that measures a water level value from the bottom of the internal space of the booth body 6100 and transmits the measured water level to the controller 2300, a water discharge line 6132, and a water discharge pump 6133 installed at the water discharge line 6132.

In response to that the water level value measured by the water level sensor 6131 reaches a preset reference water level value, the controller 2300 is configured to drive the water discharge pump 6133 to forcibly discharge the water present on the bottom of the internal space of the booth body 6100 to the outside out of the booth body 6100 through the water discharge line 6132.

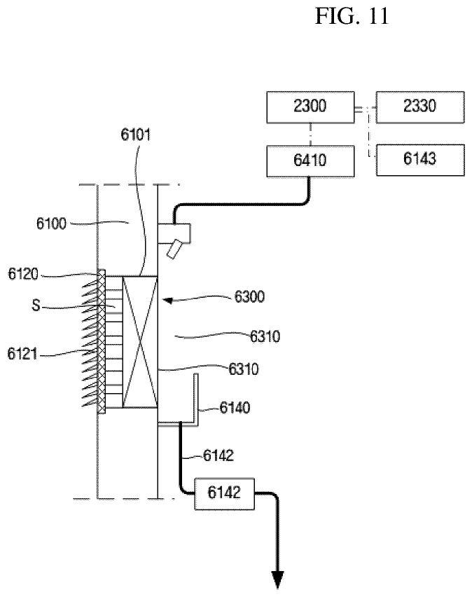

FIG. 11 is a diagram showing an example in which a water tank is disposed under the ventilation hole according to the present disclosure.

Referring to FIG. 11, a water tank 6140 is further installed under a lower end of the ventilation hole 6101.

The water tank 6140 is connected to an auxiliary water discharge line 6141.

An auxiliary water discharge pump 6142 is installed at the auxiliary water discharge line 6141.

A moisture sensor 6143 is disposed in the water tank 6140. When moisture is detected in the water tank 6140 through the moisture sensor 6143, the controller 2300 is configured to drive the auxiliary water discharge pump 6142 to forcibly discharge moisture present in the water tank 6140 to the outside out of the booth body 6100 through the auxiliary water discharge line 6141.

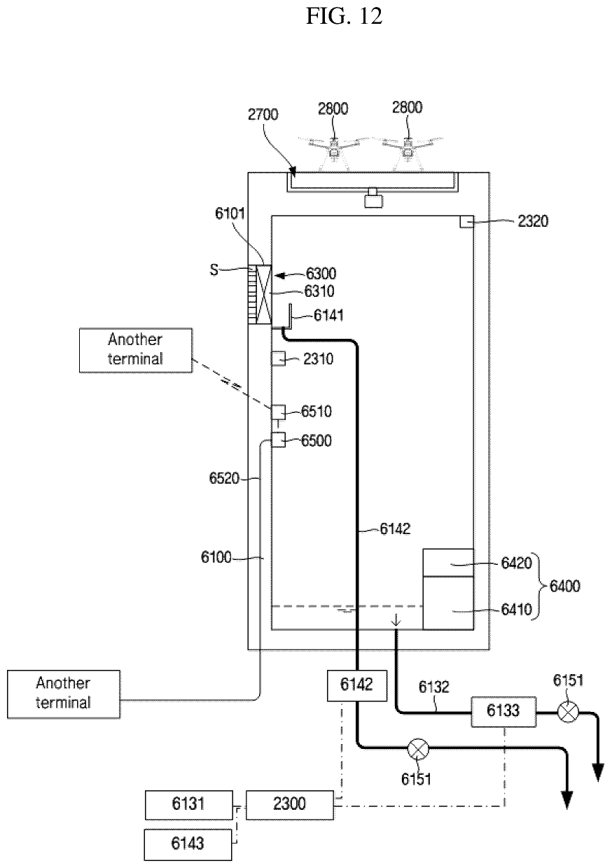

FIG. 12 is a diagram showing a water discharge line and an auxiliary water discharge line according to the present disclosure.

Referring to FIG. 12, a mesh (not shown) is further installed at an end of the water discharge line 6132 and the end of the auxiliary water discharge line 6141.

A backflow prevention valve 6151 driven under the control of the controller 2300 is further installed at each of the water discharge line 6132 and the auxiliary water discharge line 6141.

Upon receiving the victim occurrence information, the controller 2300 is configured to drive each of the backflow prevention valves 6151.

A criminal out of the booth body may inject harmful foreign substances through an end of the water discharge line 6132 and an end of the auxiliary water discharge line 6141. In this regard, the mesh prevents harmful substances of a predefined size from being introduced into the water discharge line 6132 and the auxiliary water discharge line 6141. In addition, even when the harmful substances are introduced into the water discharge line 6132 and the auxiliary water discharge line 6141, the harmful substances may be prevented from being introduced into the internal space of the booth body 6100 due to the operation of the backflow prevention valve 6151.

Thus, the victim may be protected from the harmful substances while safely resides inside the booth body 6100.

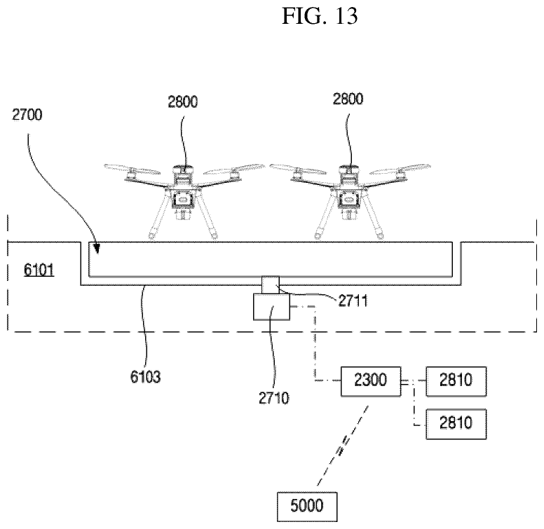

FIG. 13 is a diagram showing a drone station receiving structure according to the present disclosure.

Referring to FIG. 13, the drone station 2700 is disposed on the upper end of the booth body 6100.

A drone station receiving groove 6103 is formed in the upper end of the booth body 6100. The drone station is received in the drone receiving groove 6103 in the standby state. A lift 2710 is installed under the drone receiving groove 6103 and is driven under the control of the controller 2300.

The drone station descends into the drone station receiving groove 6103 formed in the upper end of the booth body 6100 along downward movement of the lift 2710 driven under the control of the controller 2300. The drone is in the standby state while being seated on the drone station.

The lift 2710 has a lifting shaft 2711. An upper end of the lifting shaft 2711 is connected to the lower end of the drone station 2700. The lift 2710 is driven under the control of the controller 2300.

In addition, when the controller 2300 receives the victim occurrence information, the controller 2300 is configured to drive the lift 2710 to move upwards such that the drone station is displaced out of the drone station receiving groove 6103 and to transmit the flight control signal to the drones 2800 to fly repeatedly within a set radius around the booth body 6100.

The controller 2300 is configured to drive cameras 2810 provided in the drones 2800 to capture images within a preset radius around the booth body in real time through and transmit the captured images to a main server 5000.

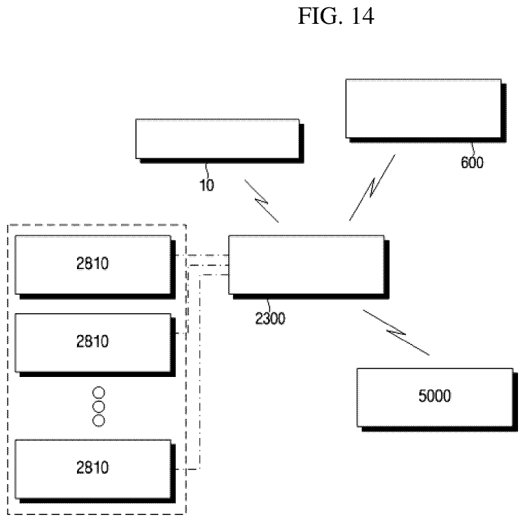

FIG. 14 is a block diagram showing a function of capturing images through drones and selecting a criminal based on the images.

Referring to FIG. 14, when the controller 2300 according to the present disclosure receives the victim occurrence information, the controller 2300 is configured to receive movement path information of the victim's wireless communication device 10 from the main server 5000.

Then, the controller 2300 is configured to control the drones 2800 to fly along the movement path information.

The controller 2300 determines whether a preset criminal image is contained in the image captured from the cameras 2810 of the drones 2800.

In response to that the preset criminal image is contained in the image captured from the cameras 2810 of the drones 2800, the controller 2300 transmits the image containing the preset criminal image to a police agency server 600.

Then, the police agency server 600 selects location information of the image containing the preset criminal image.

The police agency server 600 transmits a dispatch signal to a wireless module of a security management vehicle included within a set radius based on the selected location information.

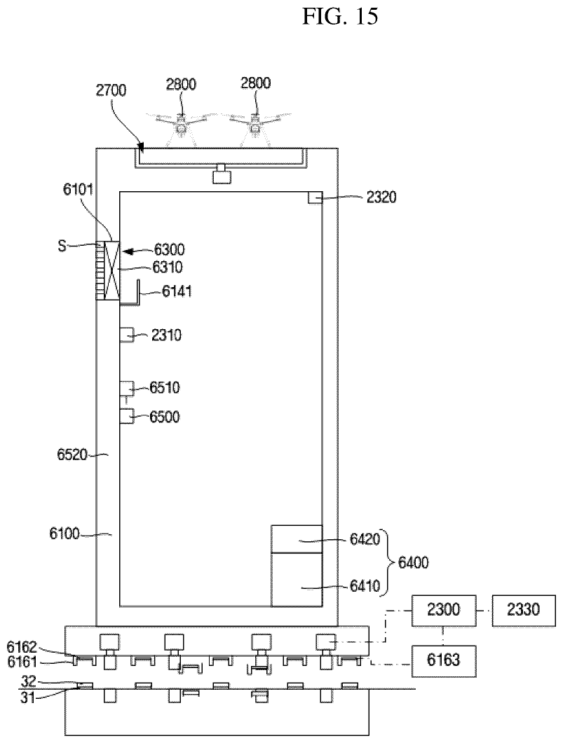

FIG. 15 is a diagram showing an example of the installation of the booth body according to the present disclosure.

Referring to FIG. 15, a base plate 6160made of metal and having a predefined thickness is installed under the lower end of the booth body 6100.

Rotators 6170 are respectively installed at multiple positions on the lower end of the base plate 6160.

Fastening members 6172 are respectively installed on rotation shafts 6171 of the rotators 6170.

An installation plate 30 having a predefined depth is installed on the ground.

Fastening blocks 40 having fastening holes 41 fastened to the fastening members 6172 are installed on the installation plate 30.

The controller 2300 rotates the rotation shafts 6171 of the rotators 6170 to fasten the fastening members 6172 to the fastening holes 41 of fastening blocks 40.

In this regard, an impact sensor 2330 for measuring an impact force from the outside and transmitting the measured impact force to the controller 2300 is installed in the booth body 6100.

First concave-convex protrusions 6161 are formed on the lower end of the base plate 6160, and second concave-convex protrusions 31 engaged with the first concave-convex protrusions 6161 are formed on the upper end of the installation plate 30. Electromagnets 6162 magnetized to have a first polarity according to the application of current are respectively installed on the first concave-convex protrusions 6161, and polar members 32 having a second polarity to generate an attractive force relative to the magnetized electromagnets 6162 are installed on the second concave-convex protrusions 31.

When the measured impact force is equal to or greater than a preset reference impact force, the controller 2300 is configured to drive a current provider 6163 to provide the current to the electromagnet 6162, thereby forcibly attaching the electromagnets 6162 and the polar members 32 to each other through a magnetic force.

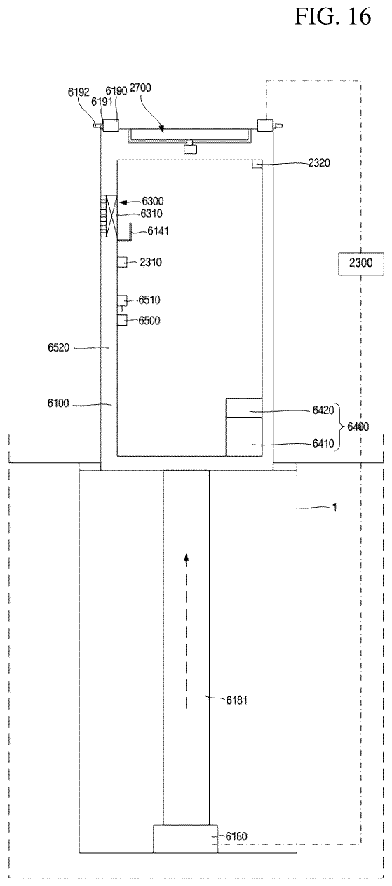

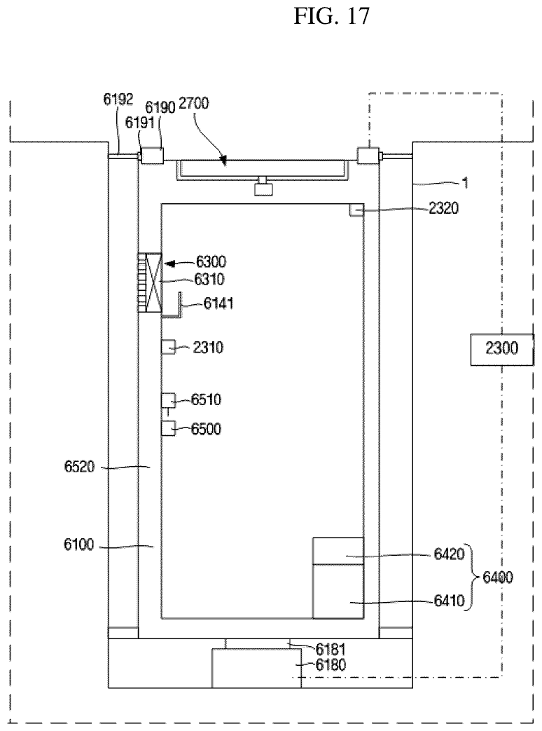

FIG. 16 is a diagram showing an example in which the booth body can be accommodated underground according to the present disclosure. FIG. 17 is a diagram showing a state in which the booth body is accommodated underground.

Referring to FIGS. 16 and 17, a lifting device 6180 is installed under the lower end of the booth body 6100.

The lifting device 6180 lifts and lowers the booth body 6100 under the control of the controller 2300.

Cover members 6192 respectively connected to the shafts 6191 of respective cylinders 6190 and constructed to outwardly protrude in all directions according to the extension operation of the shafts 6191 are disposed and arranged on and around a periphery of an upper end of the booth body 6100.

Each of the cylinders 6190 is configured to extend each of the shafts 6191 under the control of the controller 2300.

An evacuation groove 1 having a predefined depth is formed in the ground.

The lifting device 6180 lowers the booth body 6100 so as to be positioned into the evacuation groove 1.

When the lifting device 6180 lowers the booth body 6100 so as to be received into the evacuation groove 1, the controller 2300 is configured to operate each cylinder 6190 to outwardly extend each shaft 6191 of each cylinder 6190 to outwardly protrude each cover member 6192.

Accordingly, the cover members 6192 outwardly protruding in all directions may cover a top of the evacuation groove 1 such that the evacuation groove 1 is sealed.

The victim may evacuate to the internal space of the booth body 6100. The sensor 2310 recognizes the victim received in the inner space thereof and transmits the victim recognition signal to the controller 2300. Then, the controller is configured to control the opening/closing unit 6200 to close the inner space of the booth body based on the received signal.

Then, the controller 2300 may be configured to drive the lifting device 6180 to lower the booth body 6100 so as to be received inside the evacuation groove 1 formed in the ground.

In this regard, the lifting device 6180 is embodied as a lifting cylinder having a lifting shaft 6181 that moves up and down. The lifting cylinder lifts and lowers the lifting shaft 6181 under the control of the controller 2300.

The lifting cylinder are installed on the bottom of the evacuation groove 1. The upper end of the lifting shaft 6181 of the lifting cylinder is fastened and fixed to the lower end of the booth body 6100.

Therefore, under the control of the controller 2300, the lifting cylinder may be configured to operate to lower the lifting shaft 6181 such that the booth body 6100 is received inside the evacuation groove 1 formed in the ground.

Then, the controller 2300 is configured to drive the cylinders 6190 to horizontally and outwardly extend the shafts 6191 from the cylinders 6190. Accordingly, the cover members 6192 installed on and arranged around the periphery of the upper end of the booth body 6100 and respectively connected to the shafts 6191 outwardly protrude in all directions around the booth body 6100 as the shafts 6191 horizontally and outwardly extend.

In this regard, the cover members 6192 may extend between the outer side surface of the upper end of the booth body 6100 and the inner side surface of the evacuation groove 1 so as to seal the evacuation groove 1.

Thus, the booth body 6100 is lowered into the evacuation groove 1 formed underground in a state in which the victim has been evacuated to the internal space of the booth body 6100. In this way, the victim may be safely protected from criminals or criminal environments.

In addition, the cover members 6192 may extend between the outer side surface of the upper end of the booth body 6100 and the inner side surface of the evacuation groove 1 so as to seal the evacuation groove 1. Thus, the criminal may be prevented from breaking into the evacuation groove 1.

Further, although not shown in the drawings, the booth body 6100 further includes an auxiliary ventilation unit (not shown).

The auxiliary ventilation unit includes an outside air inflow pipe connecting the internal space of the booth body 6100 to a space on the ground to introduce outside air on the ground into the inner space of the booth body, an outside air inflow fan installed at the outside air inflow pipe to allow the outside air to be introduced into the inner space of the booth body under the control of the controller, and an outside air outflow pipe connecting the internal space of the booth body 6100 to the space on the ground such that the introduced outside air into the inner space of the booth body is discharged to the outside space on the ground therethrough.

Each of the outside air inflow pipe and the outside air outflow pipe may passthrough the underground and be connected to the space on the ground and may be embodied as a non-combustible and flexible pipe.

Each of an outside end of the outside air inflow pipe on the ground and an outside end of the outside air outflow pipe on the ground is formed to be inclined downwards.

Thus, the internal space of the booth body 6100 may be easily ventilated through outside air inflow and outflow while the booth body is being accommodated in the evacuation groove formed underground.

In addition, although not shown in the drawings, the booth body 6100 according to the present disclosure is provided with a camera module (not shown) that captures an image of the victim who has evacuated to the internal space of the booth body 6100 and transmits the captured image to the controller 2300.

The controller 2300 compares whether the victim's personal information included in the received victim occurrence information matches the victim's facial information included in the captured image. The personal information includes facial information.

In response to that the victim's personal information included in the received victim occurrence information matches the victim's facial information included in the captured image, the controller 2300 is configured to perform the closing operation of the opening/closing unit 6200.

Conversely, in response to that the victim's personal information included in the received victim occurrence information does not match the victim's facial information included in the captured image, the controller 2300 is configured not to perform the closing operation of the opening/closing unit. That is, the opening/closing unit 6200 is maintained in an open state without being closed.

This may prevent a case where a person other than the actual victim evacuates to the inside of the booth body 6100.

In addition, in response to that the victim's personal information included in the received victim occurrence information matches the victim's facial information included in the captured image, but the captured image further includes facial information of one or more other people than the victim, the controller 2300 is configured not to perform the closing operation of the opening/closing unit.

That is, another person besides the victim may be a criminal. In this case, the opening/closing unit is not closed so that only the victim is received inside the booth body and thus the victim is prevented from experiencing an additionally dangerous situation.

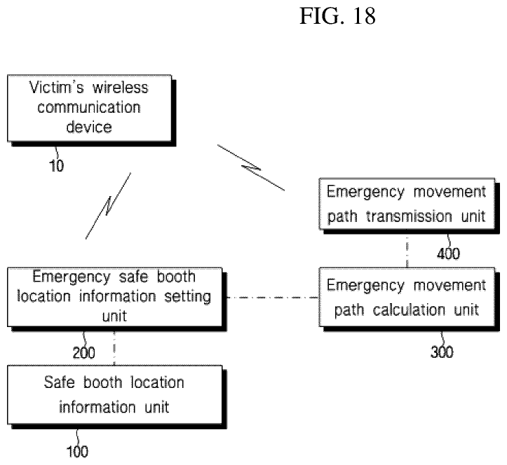

FIG. 18 is a block diagram showing a crisis response system included in the safe booth according to the present disclosure.

Referring to FIG. 18, the crisis response system of the present disclosure includes a safe booth location information unit 100 in which location information of the safe booths are set; an emergency safe booth location information setting unit 200 that receives an emergency signal from the victim's wireless communication device 10 in an emergency situation in a wireless communication manner, recognizes the location information of the victim's wireless communication device 10 from which the emergency safe booth location information setting unit 200 has received the emergency signal through the GPS (Global Positioning System), selects location information of the safe booth adjacent to the location information of the victim's wireless communication device 10from which the emergency safe booth location information setting unit 200 has received the emergency signal among the location information of the safe booths, and sets the location information of the selected safe booth as emergency safe booth location information; an emergency movement path calculation unit 300 that calculates an emergency movement path from the victim's wireless communication device location information to the set emergency safe booth location information; and an emergency movement path transmission unit 400 that transmits the calculated emergency movement path to the victim's wireless communication device 10. The victim's wireless communication device 10 includes a mobile device such as a smart phone.

The configuration and operation of the crisis response system of the present disclosure will be described.

The safe booth location information unit 100 includes an emergency signal receiving unit 110 and a victim's wireless communication device location information recognizing unit 120.

The safe booth location information unit 100 stores therein location information of the safe booths.

The emergency signal receiving unit 110 receives an emergency signal in a wireless communication manner from the wireless communication device 10 of the victim in an emergency situation.

The victim's wireless communication device location information recognizing unit 120 recognizes the location information of the victim's wireless communication device 10 that transmitted the emergency signal through the GPS (Global Positioning System).

The emergency safe booth location information setting unit 200 selects a safe booth relatively close to the victim's wireless communication device location information among the safe booths and sets the location information of the selected safe booth as emergency safe booth location information.

The emergency movement path calculation unit 300 calculates an optimal emergency movement path based on the victim's wireless communication device location information and the emergency safe booth location information.

The calculated path may be designed to avoid a crime area, a risk factor, etc. in consideration of safety.

The emergency movement path transmission unit 400 transmits the calculated emergency movement path to the victim's wireless communication device 10.

The victim's wireless communication device 10 may provide an interface through which the victim may check emergency situation information, safe booth information, emergency movement path, etc.

An example of the operation method of the crisis response system according to the present disclosure will be described.

When the victim is in an emergency situation, the victim manipulates the emergency notification app (program) pre-installed on the victim's wireless communication device 10 such that the victim's wireless communication device 10 transmits the emergency signal to the emergency signal receiving unit 110 in a wireless communication manner.

The emergency signal receiving unit 110 receives the emergency signal, and the victim's wireless communication device location information recognizing unit 120 recognizes the location information of the victim through the GPS (Global Positioning System).

The emergency safe booth location information setting unit 200 selects the safe booth closest to the victim location information and sets the location information of the selected safe booth as the emergency safe booth location information.

The emergency movement path calculation unit 300 calculates an optimal emergency movement path based on the victim location information and the emergency safe booth location information.

The emergency movement path transmission unit 400 transmits the calculated emergency movement path to the victim's wireless communication device 10.

The victim checks the emergency situation information, the safe booth information, the emergency movement path, etc. through the user interface and may safely move to the selected safe booth.

Accordingly, the system of the present disclosure may receive the victim's emergency signal in real time and provide an optimal evacuation path to support safe evacuation.

In addition, the system of the present disclosure may provide a customized evacuation path, that is, may provide a personalized evacuation path based on the victim's current location, surrounding environment around the victim, crime occurrence status, etc.

In addition, the system of the present disclosure may provide an evacuation path with enhanced safety from which the crime area, the risk factor, etc., are excluded, and may provide a user-friendly interface so as to be used easily and quickly even in emergency situations.

In addition, the system of the present disclosure may provide crime area information, crime prevention tips, etc. to help prevent the crime. The system of the present disclosure may further provide information on emergency situations such as crime occurrence information and disaster occurrence information, and may further provide a contact function with emergency agencies such as police, fire departments, and hospitals.

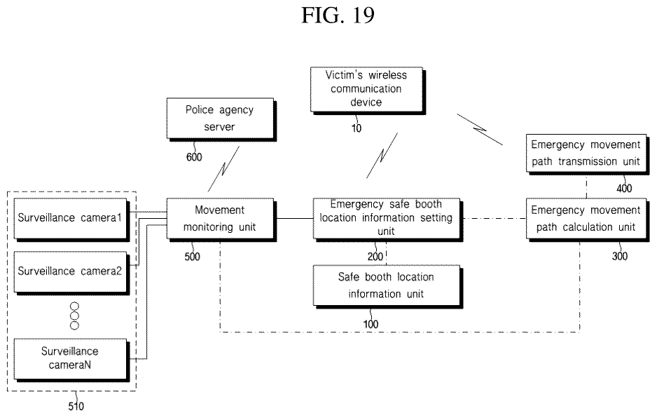

FIG. 19 is a block diagram showing an example in which a crime emergency management system or a crisis response system according to the present disclosure further includes a movement monitoring unit.

Referring to FIG. 19, the crisis response system of the present disclosure includes a movement monitoring unit 500 connected in a wireless communication manner with surveillance cameras 510 arranged along the calculated emergency movement path.

In this regard, when the victim's wireless communication device 10 moves along the calculated emergency movement path, the surveillance cameras 510 acquire images of the moving victim in real time and transmit the acquired images to the movement monitoring unit 500.

Then, the movement monitoring unit 500 determines whether the image of the victim acquired in real time exists on the calculated emergency movement path.

Then, in response to that the image of the victim acquired in real time exists on the calculated emergency movement path, the movement monitoring unit 500 recognizes this state as a safe evacuation state. To the contrary, in response to that the image of the victim acquired in real time does not exist on the calculated emergency movement path, the movement monitoring unit 500 recognizes this state as a victim damaged state.

In this regard, the movement monitoring unit 500 identifies a first location of a surveillance camera 510 capturing the image of the victim which does not exist on the calculated emergency movement path among the surveillance cameras 510, and identifies a second location of a surveillance camera 510 capturing the image of the victim which exists on the calculated emergency movement path among the surveillance cameras 510, wherein the second location is located immediately before the first location in the calculated emergency movement path.

Then, the movement monitoring unit 500 designates a path connecting the first and second locations to each other as an emergency path, and may transmit the designated emergency path, the location information of the victim's wireless communication device 10 on the designated emergency path, and the images acquired at the first and second locations to the police agency server 600 in a wireless communication manner.

The crisis response system as shown in FIG. 19 further includes the movement monitoring unit to secure the safety of the victim more effectively.

The movement monitoring unit 500 according to the present disclosure is connected in a wireless communication manner with the surveillance cameras 510 sequentially arranged along the calculated emergency movement path.

When the victim's wireless communication device 10 moves along the calculated emergency movement path, the surveillance cameras 510 acquire images of the moving victim in real time and transmit the images to the movement monitoring unit 500.

The movement monitoring unit 500 determines whether the image of the victim acquired in real time exists on the calculated emergency movement path. In response to that the image of the victim exists on the calculated emergency movement path, the movement monitoring unit 500 determines that the victim is in a safe evacuation state.

On the other hand, in response to that the image of the victim does not exist on the calculated emergency movement path, the movement monitoring unit 500 determines that the victim is in an emergency or damaged state or a damaged state.

In addition, the movement monitoring unit 500 transmits information about the victim recognized as being in the emergency or damaged state to the police agency server 600. The police agency server may promptly rescue the victim based on the victim's location information and the emergency path information.

In this regard, the specific operation method of the system is as follows.

When the victim is in an emergency situation, the victim manipulates the emergency notification app (program) pre-installed on the victim's wireless communication device 10 such that the victim's wireless communication device 10 transmits the emergency signal to the emergency signal receiving unit 110 in a wireless communication manner.

The emergency signal receiving unit 110 receives the emergency signal, and the victim's wireless communication device location information recognizing unit 120 recognizes the location information of the victim through the GPS (Global Positioning System).

The emergency safe booth location information setting unit 200 selects the safe booth closest to the victim location information and sets the location information of the selected safe booth as emergency safe booth location information.

The emergency movement path calculation unit 300 calculates an optimal emergency movement path based on the victim location information and the emergency safe booth location information.

The emergency movement path transmission unit 400 transmits the calculated emergency movement path to the victim's wireless communication device 10.

The victim checks emergency situation information, safe booth information, emergency movement path, etc. through the user interface and safely moves to the selected safe booth.

When the victim's wireless communication device moves along the calculated emergency movement path, the surveillance cameras acquire images of the moving victim in real time and transmit them to the movement monitoring unit.

The movement monitoring unit 500 determines whether the image of the victim acquired in real time exists on the calculated emergency movement path.

In response to that the image of the victim does not exist on the calculated emergency movement path, the movement monitoring unit transmits information about the victim recognized as being in an emergency or damaged state to the police agency server 600.

The police agency server 600 allows the victim to be promptly rescued based on the victim's location information and emergency path information.

The system according to the present disclosure may secure the safety of the victim more effectively and effectively shorten the response time of the police agency to the emergency state.

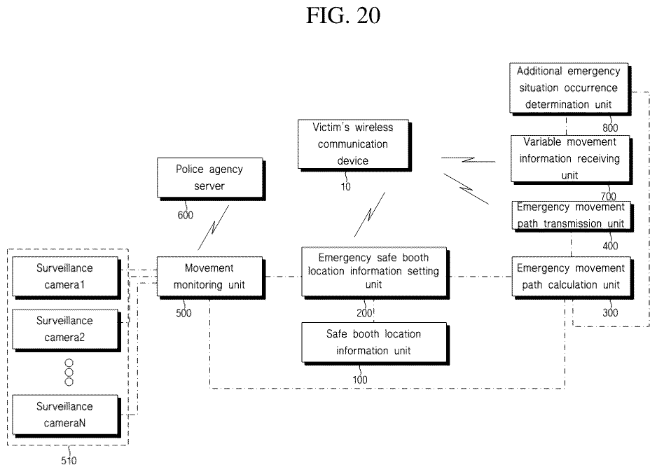

FIG. 20 is a block diagram showing an example in which the crisis response system according to the present disclosure includes a variable movement information receiving unit and an additional emergency situation occurrence determination unit.

Referring to FIG. 20, the crisis response system according to the present disclosure includes a variable movement information receiving unit 700 and an additional emergency situation occurrence determination unit 800.

The movement information of the victim's wireless communication device 10 may be variable according to the variation of the location information of the victim's wireless communication device 10. Thus, after the calculated emergency movement path is transmitted to the victim's wireless communication device 10, the variable movement information receiving unit 700 receives the variable movement information of the victim's wireless communication device 10 according to the variation of the location information of the victim's wireless communication device 10 from the victim's wireless communication device 10 in real time.

The additional emergency situation occurrence determination unit 800 determines whether the received variable movement information of the victim's wireless communication device 10 matches the emergency movement path. In response to that the received variable movement information of the victim's wireless communication device does not match the emergency movement path, the additional emergency situation occurrence determination unit 800 may determine that an additional emergency situation is occurring.

FIG. 20 shows that the safety of the victim is further enhanced by adding the variable movement information receiving unit 700 and the additional emergency situation occurrence determination unit 800 to each of the systems of FIGS. 18 and 19.

The variable movement information receiving unit 700 receives the variable movement information of the victim's wireless communication device varying in real timing whenever the location information of the victim's wireless communication device 10 changes.

The additional emergency situation occurrence determination unit 800 determines whether the received variable movement information matches the emergency movement path.

In response to that the received variable movement information does not matches the emergency movement path, the additional emergency situation occurrence determination unit 800determines that an additional emergency situation has occurred.

The operation of the system according to the present disclosure to which the variable movement information receiving unit 700 and the additional emergency situation occurrence determination unit 800 are added will be described.

When the victim is in an emergency situation, the victim manipulates the emergency notification app (program) pre-installed on the victim's wireless communication device 10 such that the victim's wireless communication device 10 transmits the emergency signal to the emergency signal receiving unit 110 in a wireless communication manner.

The emergency signal receiving unit 110 receives the emergency signal, and the victim's wireless communication device location information recognizing unit 120 recognizes the location information of the victim through the GPS (Global Positioning System).

The emergency safe booth location information setting unit 200 selects the safe booth closest to the victim location information and sets the location information of the selected safe booth as emergency safe booth location information.

The emergency movement path calculation unit 300 calculates an optimal emergency movement path based on the victim location information and the emergency safe booth location information.

The emergency movement path transmission unit 400 transmits the calculated emergency movement path to the victim's wireless communication device 10.

The victim checks emergency situation information, safe booth information, emergency movement path, etc. through the user interface and safely moves to the selected safe booth.

In response to that the victim's movement path does not match the emergency movement path, the variable movement information receiving unit receives the variable movement information in real time.

The additional emergency situation occurrence determination unit 800 determines whether the received variable movement information matches the emergency movement path. I response to that the received variable movement information does not match the emergency movement path, the additional emergency situation occurrence determination unit 800 determines that an additional emergency situation has occurred and transmits a notification of the determination result to the police agency server 600.

The police agency server 600 receives the notification and may promptly rescue the victim based on the victim's location information and situation information.

The system of the present disclosure may track the victim's movement path in real time to respond quickly in the event of an emergency situation.

A practical example of the system to which the above configuration is applied will be described.

In response to that a victim moves along the emergency movement path and suddenly changes a movement direction and moves to another path, the additional emergency situation occurrence determination unit 800 determines that an additional emergency situation has occurred and transmits a notification of the determination result to the police agency server 600.

In addition, in response to that the victim collapses or falls down or loses consciousness in the middle of the emergency movement path and cannot move, the variable movement information receiving unit 700 may no longer receive the variable movement information from the victim's wireless communication device 10. In this case, the additional emergency situation occurrence determination unit 800 may determine that the victim is in an emergency situation or damaged state and transmit a notification of the determination result to the police agency server 600.

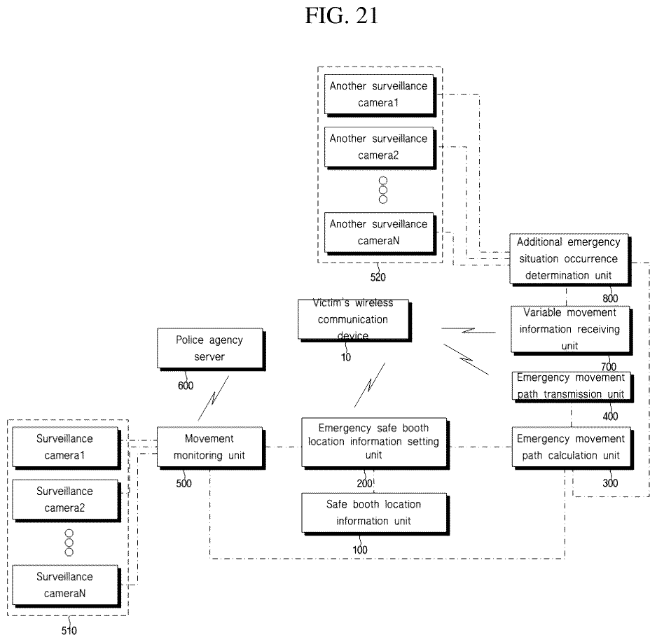

FIG. 21 is a block diagram showing the operation of the additional emergency situation occurrence determination unit according to the present disclosure.

Referring to FIG. 21, the additional emergency situation occurrence determination unit 800 according to the present disclosure transmits, to the police agency server 600, the location information of the victim's wireless communication device 10 identified through the GPS (Global Positioning System) at the timing when the additional emergency situation occurs.

In addition, in response to that the location information of the victim's wireless communication device 10 is not identified through the GPS (Global Positioning System) at the timing when the additional emergency situation occurs, the additional emergency situation occurrence determination unit 800 sets an additional emergency area having a set radius around the point where the additional emergency situation occurred.

Then, the additional emergency situation occurrence determination unit 800 acquires additional images through other surveillance cameras 520 included in the set additional emergency area, and transmits information on the set additional emergency area and the acquired additional images to the police agency server 600.

Under the above configuration, in response to that the victim's wireless communication device 10 deviates from the emergency movement path or the variable movement information receiving unit 700 no longer receives the variable movement information, the additional emergency situation occurrence determination unit 800 determines that an additional emergency situation has occurred.

The additional emergency situation occurrence determination unit 800 transmits the following information to the police agency server 600.

The emergency situation occurrence time may be the timing when the additional emergency situation occurred.

In addition, the victim's wireless communication device location information may be the location information of the victim's wireless communication device identified through the GPS (Global Positioning System) (if identifiable).

The additional emergency area may be an area of a radius set based on the location information of the victim's wireless communication device 10 (if the victim's wireless communication device location information cannot be identified).

The additional image may be an image acquired from other surveillance cameras 520 included in the additional emergency area.

A practical example of the system to which the above-described configuration is applied will be described.

In response to that the victim moves along the emergency movement path and suddenly changes the moving direction and moves to another path, the additional emergency situation occurrence determination unit 800 determines that an additional emergency situation has occurred and transmits a notification of the determination result to the police agency server 600.

The police agency server 600 searches for the victim based on the victim's last location information and additional emergency area information.

In response to that the victim collapses or falls down or loses consciousness in the middle of the emergency movement path and cannot move, the variable movement information receiving unit 700 may no longer receive the variable movement information from the victim's wireless communication device 10.

In this case, the additional emergency situation occurrence determination unit 800 may determine that an additional emergency situation has occurred and transmit a notification of the determination result to the police agency server 600.

The police agency server 600 sets an additional emergency area based on the victim's last location information and may find the victim through surveillance cameras within the set additional emergency area.

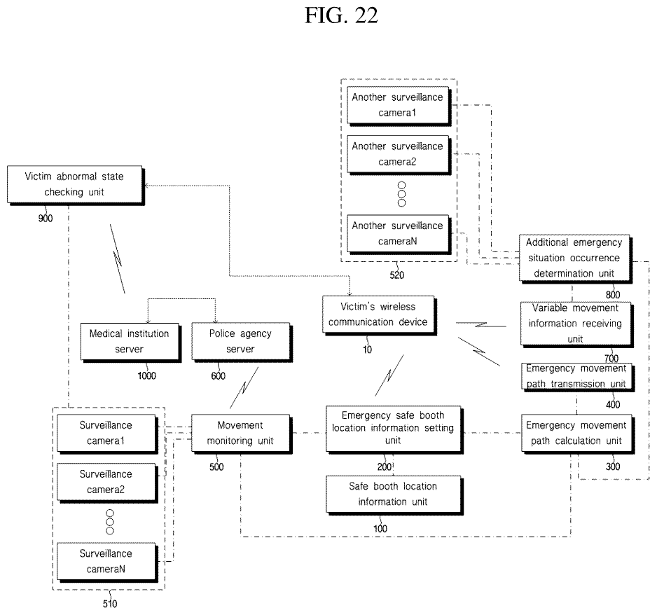

FIG. 22 is a block diagram showing an example in which a crime emergency management system according to the present disclosure includes a victim abnormal state checking unit.

Referring to FIG. 22, the crime emergency management system according to the present disclosure includes a victim abnormal state checking unit 900.

The victim abnormal state checking unit 900 may process images acquired in real time by the surveillance cameras 510.

Then, the victim abnormal state checking unit 900 calculates the moving speed of the victim based on the victim image included in the captured image.

When the calculated moving speed of the victim decreases to a preset abnormal speed or the calculated moving speed of the victim is calculated as 0, the victim abnormal state checking unit 900 determines this state as a victim abnormal state.

The victim abnormal state checking unit 900 may transmit the determination result of the victim abnormal state and the location information of the victim's wireless communication device 10 at the timing at which it is determined that the victim state is the victim abnormal state to a medical institution server 1000 located within a set radius around the location information of the victim's wireless communication device 10 in a wireless communication manner.

The operation of the victim abnormal state checking unit of FIG. 22 will be described.

When the victim is in an emergency situation, the victim manipulates the emergency notification app (program) pre-installed on the victim's wireless communication device 10 such that the victim's wireless communication device 10 transmits the emergency signal to the emergency signal receiving unit 110 in a wireless communication manner.

The emergency signal receiving unit 110 receives the emergency signal, and the victim's wireless communication device location information recognizing unit 120 recognizes the location information of the victim through the GPS (Global Positioning System).

The emergency safe booth location information setting unit 200 selects the safe booth closest to the victim location information and sets the location information of the selected safe booth as emergency safe booth location information.

The emergency movement path calculation unit 300 calculates an optimal emergency movement path based on the victim location information and the emergency safe booth location information.

The emergency movement path transmission unit 400 transmits the calculated emergency movement path to the victim's wireless communication device 10.

The victim checks emergency situation information, safe booth information, emergency movement path, etc. through the user interface and safely moves to the selected safe booth.

While the victim's wireless communication device 10 moves, the surveillance cameras 510 acquire images of the moving victim in real time and transmit the images to the victim abnormal state checking unit 900.

The victim abnormal state checking unit 900 calculates the moving speed of the victim from the captured image.

In response to that the moving speed of the victim decreases to a preset abnormal speed or is calculated as 0, the victim abnormal state checking unit 900 determines that the victim state is a victim abnormal state.

The victim abnormal state checking unit 900 may transmit the determination result of the victim abnormal state and the location information of the victim's wireless communication device 10 at the timing at which it is determined that the victim state is the victim abnormal state to a medical institution server 1000 located within a set radius around the location information of the victim's wireless communication device 10 in a wireless communication manner.

A practical example of the system to which the above configuration is applied will be described.

When a victim suddenly collapses or falls downs or loses consciousness while moving along the emergency movement path and cannot move, the victim's moving speed is calculated as 0. The victim abnormal state checking unit 900 detects this state, determines that the victim state is a victim abnormal state, and transmits a notification of the determination result to the medical institution server 1000.

Further, when the victim collapses due to an attack by a criminal, the victim's moving speed decreases drastically.

The victim abnormal state checking unit 900 detects this state, determines that the victim state is a victim abnormal state, and transmits a notification of the determination result to the police agency server 600 and the medical institution server 1000.

Accordingly, the system of the present disclosure may secure the safety of the victim more effectively and may shorten the response time of police agencies and medical institutions to the emergency state, and may help prevent crime damage and save the victim's life.

In addition, the medical institution server 1000 may simultaneously transmit the received determination result of the victim abnormal state and the location information of the victim's wireless communication device at the timing at which it is determined that the victim is in the victim abnormal state to the police agency server 600 in a wireless communication manner.

The crime emergency management system shown in FIG. 22 may additionally provide a function of providing prompt medical support in conjunction with the medical institution server 1000 when the victim abnormal state occurs. This may play a very important role in saving the victim's life.

The victim abnormal state checking unit 900 transmits a determination result of the victim abnormal state and the victim's location information to the medical institution server 1000.

The medical institution server 1000 takes the following actions based on the received information.

The medical institution server 1000 may transmit the notification of the victim abnormal state to the nearest hospital or medical staff's wireless communication device based on the victim's location information to request prompt dispatch thereof.

Furthermore, the medical institution server 1000 may prepare necessary medical resources in preparation for an emergency situation based on the victim's condition information.

Furthermore, the medical institution server 1000 may communicate with the wireless communication device of the victim's family or acquaintance to inform them of the emergency situation and request them to take necessary actions. This may be a case where permission to share contacts stored in the victim's wireless communication device 10 has been obtained from the victim in advance.

Accordingly, the system of the present disclosure may increase the possibility of saving the victim's life through rapid medical support.

In addition, the medical institution server 1000 of the present disclosure may efficiently provide medical services by grasping the victim's condition information in advance.

In addition, the medical institution server 1000 of the present disclosure may relieve anxiety by continuously informing the victim's family or acquaintance of the situation.

A practical example of the system to which the above configuration is applied will be described.

In response to that a victim is seriously injured by an attack by a criminal, the victim abnormal state checking unit 900 determines that the victim state is a victim abnormal state and transmits a notification of the determination result to the medical institution server.

The medical institution server 1000 transmits a notification of the determination result to a nearby hospital to the victim's location to provide prompt first aid.

Furthermore, in response to that the victim collapses due to a sudden illness such as a heart attack or stroke, the victim abnormal state checking unit 900 determines that the victim state is a victim abnormal state and transmits a notification of the determination result to the medical institution server 1000. The medical institution server 1000 may immediately transmit the rescue request to the police agency server 600 to make a prompt rescue request.

The crime emergency management system according to the present disclosure may interwork with the medical institution server 1000 to play an important role in protecting the safety of victims and saving lives.

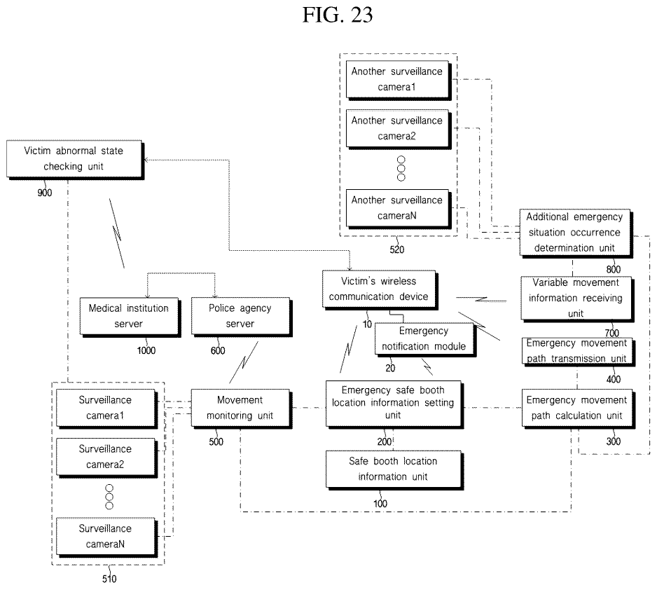

FIG. 23 is a block diagram showing a configuration including an example in which an emergency notification module operates in a remote control manner.

In addition, when the emergency safe booth location information setting unit 200 receives the emergency signal from the victim's wireless communication device 10 in a wireless communication manner, the emergency safe booth location information setting unit 200 may forcibly drive the emergency notification module 20 included in the victim's wireless communication device 10 in a remote control manner.

Accordingly, the emergency safe booth location information setting unit 200 additionally provides a function of further securing the victim's safety by forcibly driving the emergency notification module 20 when a victim's emergency situation occurs. This allows the victim to ask for help from surrounding people or inform them of his/her location information when the victim is in an emergency situation.

The process in which the system having the above configuration operates will be described.

When the victim is in an emergency situation, the victim manipulates the emergency notification app (program) pre-installed on the victim's wireless communication device 10 such that the victim's wireless communication device 10 transmits the emergency signal to the emergency signal receiving unit 110 in a wireless communication manner.

The emergency signal receiving unit 110 receives the emergency signal, and the victim's wireless communication device location information recognizing unit 120 receives the emergency signal from the victim's wireless communication device 10 in a wireless communication manner.

The emergency safe booth location information setting unit 200 may take the following actions based on the received emergency signal.

The emergency safe booth location information setting unit 200 forcibly drives the emergency notification module 20 included in the victim's wireless communication device 10 in the remote control manner.

The emergency notification module 20 may ask for help by notifying surrounding people of the victim's emergency situation information (location information, emergency situation type, etc.).

The emergency notification module 20 transmits the victim's location information to the police agency server 600 or the medical institution server 1000, etc., enabling a prompt response to the emergency state.

In accordance with the present disclosure, the emergency safe booth location information setting unit 200 may forcibly drive the emergency notification module 20 without the victim's consent thereto. This is to allow the help for the victim to be requested even when the victim is in an emergency situation and cannot operate the emergency notification module directly.

Furthermore, when the emergency situation occurs, the emergency safe booth location information setting unit 200 automatically forcibly drives the emergency notification module 20, thereby enabling a prompt response thereto.

In addition, the emergency notification module 20 may notify surrounding people of emergency situation information in various ways such as voice notification, text message, and screen notification.

This may help secure the safety of the victim by allowing the surrounding people around the victim to ask for help from the surrounding people or allowing the surrounding people to inform the location information of the victim to the police agency server 600 and the medical institution server 1000.

Furthermore, the surrounding people may promptly provide the victim's location information to the police agency server 600 and the medical institution server 1000 which in turn can take a prompt response thereto.

When the criminal commits a crime, the possibility that the crime is caught by surrounding people increases. Thus, a crime prevention effect may be expected.

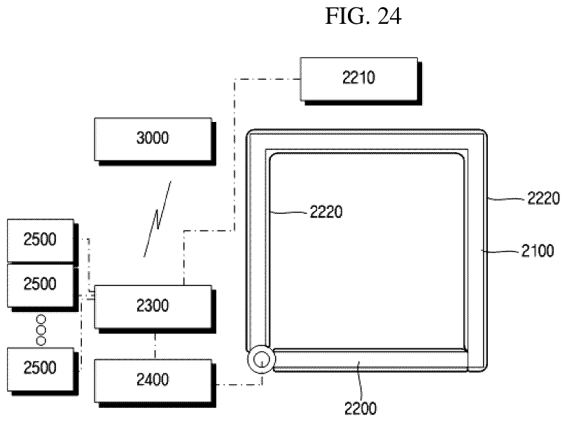

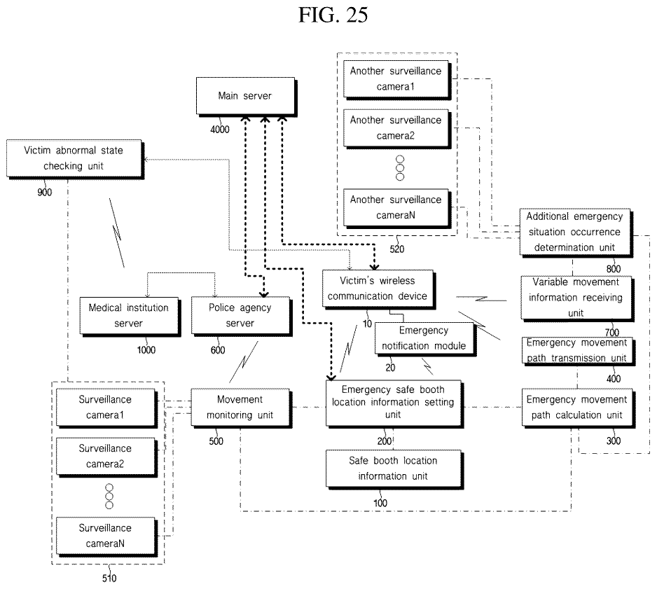

FIG. 24 is a diagram showing an example of the configuration of a smart safe booth according to the present disclosure. FIG. 25 is a block diagram showing a crime emergency management system including a monitoring server.

Each of the safe booths 2000 includes a booth body 2100 installed at a corresponding local location, having an evacuation space formed therein, and having an entrance formed at one side, a door 2200 installed on the booth body 2100 and opening and closing the entrance, and a driver 2400 opening and closing the door 2200 under the control of a controller 2300.

The controller 2300 is configured to receive a remote control signal from a monitoring server 3000 and to operate based on the received remote control signal.

When the location information of the victim's wireless communication device 10 is located within a set proximity distance from the emergency safe booth location information, the monitoring server 3000 is configured to control the controller 2300 to operate the driver 2400 to open the door 2200 of the safe booth 2000 located at the emergency safe booth location information.

When the location information of the victim's wireless communication device 10 approaches the evacuation space of the booth body 2100, the monitoring server 3000 is configured to control the controller 2300 to operate the driver 2400 to forcibly close the door 2200.

In addition, air filling members 2220 filled with air by an air filler 2210 are installed on the inner and outer side surfaces of the booth body 2100 and the door 2200.

An impact sensor 2500 is provided on each of the booth body 2100 and the door 2200 to detect an external impact force.

The safety of the safe booth 2000 may be further strengthened by adding the air filled member 2220 and the impact sensor 2500 to the booth body 2100 and the door 2200.

The effect of the air filled member 2220 will be described.

The air filled member 2220 is present inside and outside the safe booth. Then, the air filled member 2220 may expand based on the impact sensor detection result. This may allow the victim to stay safely and comfortably in the booth after the evacuation in response to internal and external impacts.

The booth body of the safe booth may be designed to be made of a bulletproof material and a fireproof material. This protects the victim from attacks by criminals and helps secure a safe evacuation time even in the event of a fire.

The impact sensor 2500 according to the present disclosure may transmit detected information to the monitoring server 3000 or the police agency server 600 to enable a prompt rescue request.

When the location information of the victim's wireless communication device 10 approaches the evacuation space of the booth body 2100 and the detected external impact force is equal to or greater than an emergency impact force set in the controller in a state in which the door 2200 is forcibly closed, the monitoring server 3000 is configured to transmit information on the possibility of a criminal's intrusion to the police agency server 600 in a wireless communication manner.

The monitoring server 3000 is configured to generate an emergency situation alarm to the outside using a speaker 2600 provided on the safe booth 2000.

The process in which the system having the above configuration operates will be described.

When the victim is in an emergency situation, the victim manipulates the emergency notification app (program) pre-installed on the victim's wireless communication device 10 such that the victim's wireless communication device 10 transmits the emergency signal to the emergency signal receiving unit 110 in a wireless communication manner.

The emergency signal receiving unit 110 receives the emergency signal, and the victim's wireless communication device location information recognizing unit 120 recognizes the location information of the victim through the GPS (Global Positioning System).

The emergency safe booth location information setting unit 200 selects the safe booth 2000 closest to the victim location information and sets the location information of the selected safe booth 2000 as emergency safe booth location information.

The emergency movement path calculation unit 300 calculates an optimal emergency movement path based on the victim location information and the emergency safe booth location information.

The emergency movement path transmission unit 400 transmits the calculated emergency movement path to the victim's wireless communication device 10.

While the victim moves along the emergency movement path, the monitoring server 3000 tracks the victim's wireless communication device location information in real time.

When the victim's wireless communication device location information is located within a set proximity distance from the emergency safe booth location information, the monitoring server 3000 is configured to drive the driver to automatically open the door 2200 of the safe booth 2000.

When the victim has safely entered the inside of the safe booth 2000, the monitoring server 3000 is configured to drive the driver to automatically close the door 2200 of the safe booth 2000.

In response to that a victim runs away under attack by a criminal, the victim manipulates the emergency notification app (program) pre-installed on the victim's wireless communication device 10 such that the victim's wireless communication device 10 transmits the emergency signal to the emergency signal receiving unit 110 in a wireless communication manner. The system according to the present disclosure selects the closest safe booth based on the victim's location information and automatically opens the door of the safe booth. Thus, the victim may safely enter the inside of the safe booth and hide therein.

The system according to the present disclosure may more effectively secure the safety of the victim, reduce the required victim's evacuation time by automating the evacuation process, block the approach of the criminals to the victim, and protect the victim.

In one example, the crime emergency management system according to the present disclosure includes a main server 4000.

The main server 4000 has a user information storage module 4100 capable of storing information of a user which may use the service of the system according to the present disclosure.

Unique ID information of wireless communication devices 10 of the users may be stored in the user information storage module 4100. Accordingly, the main server 4000 may grant permission to allow only the wireless communication devices 10 of the IDs stored in the user information storage module 410 to use the above-mentioned system of the present disclosure. That is, the victim's wireless communication device 10 is one of the wireless communication devices 10 having the IDs stored in the user information storage module 410.

The main server 4000 may grant use permission of the system to the wireless communication device 10 through paid payment for use for a predefined period.

However, in a limited manner to the case where the emergency notification app having a user interface is installed on a wireless communication device for which the use permission has not been granted, the system according to the present disclosure may be used in an emergency situation by the wireless communication device, and payment for the use may be guided by guiding the wireless communication device to pay a paid fee per use after a predefined period of use.

That is, the system of the present disclosure may allow for free use in the emergency situations and guide the post-payment for the use.

For example, in response to that a victim is in an emergency situation under attack by a criminal, the victim's wireless communication device may transmit the emergency signal by the victim executing the emergency notification app even when the use permission is not granted for the victim's wireless communication device.

The system according to the present disclosure receives the victim's emergency signal and provides safe booth information, emergency movement path, etc. to secure the victim's safety.

After the emergency situation is resolved, the system according to the present disclosure transmits a usage fee payment guide to the victim, and the victim pays for the usage fee according to the guide.

Thus, the system of the present disclosure may provide an opportunity to use the system to all people in emergency situations.

In addition, the system of the present disclosure may promote expansion of system use by providing potential users with an opportunity to experience the system.

Furthermore, the system of the present disclosure may remove the use fee burden on the victim in the event of an emergency situation and allow the user to perform the post-payment for the use, such that the system utilization rate may be increased.

According to the overall configuration and operation as described above, the system of the present disclosure guides the victim in the emergency situation due to the occurrence of a crime in an external space in real time so that the victim may immediately evacuate to an adjacent safe booth, thereby effectively preventing crime damage.

In addition, the system of the present disclosure guides a path along which the victim evacuates to the safe booth, tracks the situation in which the victim moves along the evacuation path in real time, and monitors in real time whether an additional emergency situation occurs on the evacuation path when the victim moves.

In addition, when an emergency situation occurs on the victim, the system of the present disclosure transmits the emergency situation to the police agency server and medical institution server 1000 adjacent to the victim, monitors whether the victim moves safely along the evacuation path based on image information acquired from surveillance cameras 510 capable of monitoring the evacuation path. In response to that an additional emergency situation occurs, the system additionally transmits accurate information on the additional emergency situation to the police agency server 600 and the medical institution server 1000 so that the emergency situation may be resolved immediately by the police agency server 600 and the medical institution server 1000.

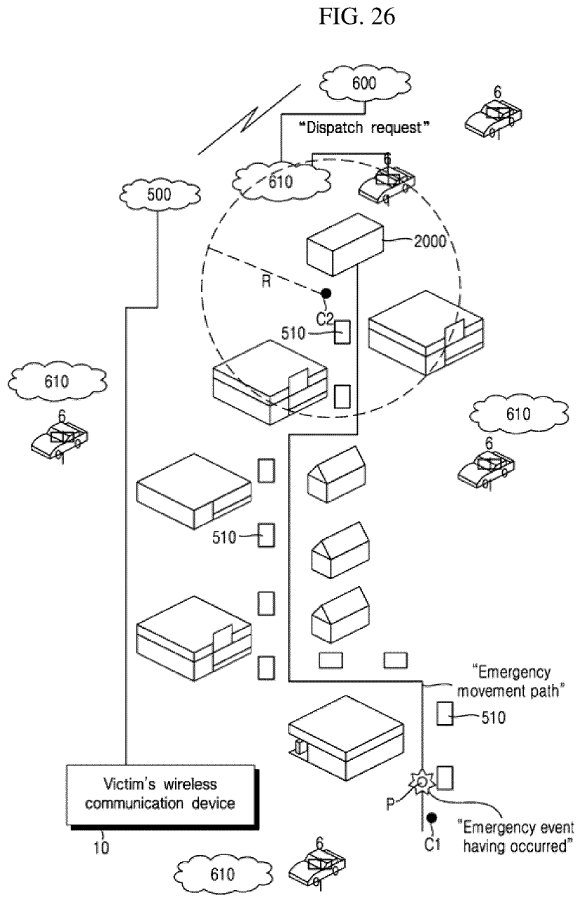

FIG. 26 is a diagram showing an example of suppressing the occurrence of additional crimes.

Referring to FIG. 26, when an emergency situation occurs due to a criminal act of a first criminal C1 on the street, the victim P receives the calculated emergency movement path as described above through the victim P's wireless communication device 10 and may be guided to move to a selected safe booth 2000. Further, the victim P may move along the emergency movement path.

A second criminal C2 who conspired with the first criminal C1 may be waiting around the selected safe booth 2000. In this case, even when the victim P moves along the emergency movement path, he/she may be exposed to the second criminal C2 and additional damage may occur on the victim P.

The surveillance cameras 510 are sequentially arranged on the emergency movement path. The surveillance cameras 510 acquire the images of the moving victim, and the movement monitoring unit 500 receives the images and transmits the images to the police agency server 600 in real time in a wireless communication manner.

The police agency server 600 specifies a person moving close to the victim moving on the emergency movement path as a criminal candidate, and temporarily stores therein personal information including facial information and physical information of the specified criminal candidate.

In this regard, personal information including facial information of existing criminals who have been punished for committing crimes is pre-stored in the police agency server 600.

The police agency server 600 determines whether the temporarily stored personal information of the criminal candidate matches the personal information of the existing criminals.

In response to that the temporarily stored personal information of the criminal candidate matches the personal information of the existing criminals, the police agency server 600 sets him/her as the first criminal C1.

In response to that an image of specific facial information among the facial information of people contained in the images acquired from the surveillance cameras 510 sequentially arranged along the emergency movement path and transmitted to the police agency server 600 as described above matches the personal information of the existing criminals, the police agency server 600 sets him/her having the specific facial information as the second criminal C2.

The second criminal C2 may exist at any location on the emergency movement path or may exist around the selected safe booth.

When the first criminal C1 and the second criminal C2 exist at the same time as described above, the security management server 600 immediately grasps the location information of the first and second criminals.

The security management server 600 transmits the location information of each of the first and second criminals and the personal information of each of the first and second criminals to each local security management server 610 located within a predefined radius R from each of the location information of the first criminal C1 and the location information of the second criminal C2.

Then, each local security management server 610 transmits dispatch instruction information to the wireless communication device 611 of a patrol car patrolling in the area located within a predefined radius R from each of the location information of the first criminal C1 and the location information of the second criminal C2. Upon reception of the dispatch instruction information, each patrol car may move to the location information of each of the first and second criminals.

Accordingly, each patrol car is dispatched to the location information of each of the first and second criminals. Thus, the victim may be protected as much as possible from additional crime damage caused by the second criminal C2 while the victim is moving to evacuate to the selected safe booth 2000.

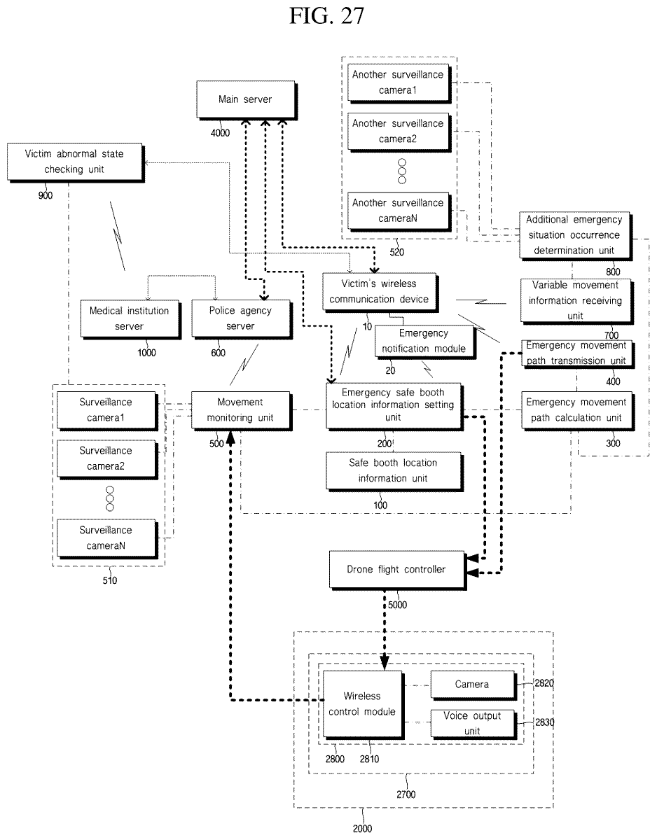

FIG. 27 is a block diagram showing an operation of a crime emergency management system including a drone flight controller.

Referring to FIG. 27, the crime emergency management system according to the present disclosure may include a drone flight controller 5000.

The drone station 2700 is provided on each of the safe booths 2000. A drone 2800 capable of flying using its own battery as power is seated on the drone station 2700. The drone 2800 includes a wireless control module 2810 that performs wireless communication with the drone flight controller 5000.

The drone flight controller 5000 transmits a flight control signal to the wireless control module 2810 of each drone 2800 provided on each of the safe booths 2000 to control the flight of each drone 2600 seated on each of the safe booths 2000.

The drone flight controller 5000 receives the location information of the victim's wireless communication device 10 from the emergency safe booth location information setting unit 200.

The drone flight controller 5000 receives the calculated emergency movement path from the emergency movement path transmission unit 400.

The drone flight controller 5000 controls the drone 2800 seated on the selected safe booth 2000 to fly to an area corresponding to the location information of the victim's wireless communication device 10.

Accordingly, the drone 2800 flies along a flight path in accordance with the movement of the location information of the victim's wireless communication device 10, acquires images of the victim in real time using the video camera 2820 disposed thereon, and transmits the images to the movement monitoring unit 500 according to the present disclosure.

The drone flight controller of the present disclosure controls the drone 2800 to fly to acquire images of the victim moving to the selected safe booth 2000 and images of criminals as videos using the video camera 2820 disposed thereon, and transmit the acquired images to the security management server 600 through the movement monitoring unit 500, thereby preventing the blind spot from occurring in sections where the surveillance cameras 510 are not installed. Thus, the victim may move safely to the safe booth.

In addition, a voice output unit 2830 is provided in the drone 2800. A warning message is transmitted in a voice manner to the surroundings around the victim moving along the emergency movement path through the voice output unit 2830. Accordingly, criminals threatening the victim may receive the warning through the transmitted warning message and stop the criminal act. Therefore, the system of the present disclosure may significantly lower the crime rate against the victims.

The present disclosure has been described above with reference to the drawings illustrated in the present disclosure. However, the present disclosure is not limited by the embodiments and drawings disclosed in the present disclosure, and it is obvious that various modifications may be made thereto by a person skilled in the art within the scope of the technical idea of the present disclosure. In addition, even when the effects according to the configuration of the present disclosure are not explicitly described and set forth while describing the embodiments of the present disclosure, it is obvious that the predictable effects therefrom should also be recognized.

What is claimed is:

1. A smart safe booth for crime prevention, the smart safe booth comprising:
a booth body disposed at a predefined location on the ground and having an internal space defined therein;
an opening/closing unit provided at a predefined position of the booth body to open and close the internal space of the booth body;
a ventilation unit disposed in the internal space of the booth body to ventilate the internal space of the booth body;
a fire extinguishing unit for suppressing a fire when a fire occurs in the internal space of the booth body;
a communication unit disposed in the internal space of the booth body to perform communication with an external communication device in a wired or wireless communication manner;
a drone station disposed on a top of the booth body, where a drone flying based on a flight control signal is seated on the drone station in a standby state; and
a controller configured to control an operation of each of the opening/closing unit, the ventilation unit, the fire extinguishing unit, and the communication unit, and to transmit the flight control signal to the drones to control the flight of the drones,
wherein the controller is configured to:
receive victim occurrence information including a victim's personal information and location information of a victim's wireless communication device from a main server in a wireless communication manner;
in response to that the location information of the victim's wireless communication device approaches location information of the booth body, drive the opening/closing unit to open the internal space of the booth body; and
in response to that the victim is located in the internal space of the booth body, drive the opening/closing unit to close the internal space of the booth body,
wherein the booth body is made of bulletproof metal,
wherein the booth body is provided with a water discharge unit,
wherein the water discharge unit includes: a water level sensor for measuring a water level value from a bottom of the internal space of the booth body and transmitting the measured water level to the controller; a water discharge line; and a water discharge pump installed at the water discharge line,
wherein in response to that the water level value measured by the water level sensor reaches a preset reference water level value, the controller is configured to drive the water discharge pump to forcibly discharge water present on the bottom of the internal space of the booth body to an outside out of the booth body through the water discharge line.

2. The smart safe booth for crime prevention according to claim 1, wherein a flame-retardant layer having a predefined thickness is formed on each of an outer surface and an inner surface of the booth body.

3. The smart safe booth for crime prevention according to claim 1, wherein the ventilation unit includes a fan module rotated under control of the controller,
wherein a ventilation hole is formed at a predefined position of the booth body,
wherein the fan module is installed in the ventilation hole,
wherein a grill member covering the ventilation hole and having a predefined strength or greater is installed in the booth body,
wherein anti-intrusion pins protruding sharply outwardly are formed at multiple positions of the grill member,
wherein each of the anti-intrusion pins extends to be inclined downwards.

4. The smart safe booth for crime prevention according to claim 3, wherein the fire extinguishing unit further includes an auxiliary sprayer for spraying a fire extinguishing agent into the ventilation hole,
wherein a temperature sensor for measuring a temperature value and transmitting the measured temperature value to the controller is provided in the ventilation hole,
wherein in response to that the temperature value measured by the temperature sensor in the ventilation hole reaches a preset abnormal temperature value, the controller is configured to operate the auxiliary sprayer.

5. The smart safe booth for crime prevention according to claim 1, wherein a water tank is further installed under a lower end of the ventilation hole,
wherein the water tank is connected to an auxiliary water discharge line,
wherein an auxiliary water discharge pump is installed at the auxiliary water discharge line,
wherein a moisture sensor is disposed in the water tank,
wherein in response to that the moisture sensor detects moisture in the water tank, the controller is configured to operate the auxiliary water discharge pump to forcibly discharge the moisture formed in the water tank to the outside out of the booth body through the auxiliary water discharge line.

6. The smart safe booth for crime prevention according to claim 1, wherein a drone station receiving groove is formed in the upper end of the booth body,
wherein a lift is installed under the drone receiving groove and is connected to the drone station,
wherein the controller is configured to drive the lift to move downwardly such that the drone station descends and is received into the drone station receiving groove such that the drone is in the standby state while being seated on the drone station.

7. The smart safe booth for crime prevention according to claim 1, wherein the controller is configured to:
upon receiving the victim occurrence information, transmit the flight control signal to the drone;
control the drone to fly repeatedly within a set radius around the booth body; and
control a camera provided in the drone to capture an image of a scene within the set radius in real time and to transmit the captured image to the main server.
